(19) United States
(12) Patent Application Publication
(10) Pub. No.: US 2018/0039514 A1
(43) Pub. Date: Feb. 8, 2018

(54) METHODS AND APPARATUS TO FACILITATE EFFICIENT SCHEDULING OF DIGITAL TASKS IN A SYSTEM

(71) Applicant: General Electric Company, Schenectady, NY (US)

(72) Inventors: Hongwei LIAO, Niskayuna, NY (US); Panagiotis MANOLIOS, Sharon, MA (US); Terrell Michael BRACE, Grand Rapids, MI (US); Gregory Reed SYKES, Grand Rapids, MI (US); Kevin J. JONES, Grand Rapids, MI (US); Kit Yan SIU, Niskayuna, NY (US)

(21) Appl. No.: 15/229,814

(22) Filed: Aug. 5, 2016

(51) Int. Cl. G06F 9/48

(52) U.S. Cl. CPC G06F 9/4887; G06F 9/4837

(57) ABSTRACT

Methods, apparatus, systems and articles of manufacture to facilitate efficient scheduling of digital tasks in a system are disclosed. Periodic and aperiodic tasks may be identified, an initial minimum required duration may be determined based on the periodic and aperiodic tasks, a finish-to-activate duration of the aperiodic task may be determined, a final minimum required duration may be determined based on the initial minimum required duration and the finish-to-activate duration, a time budget may be adjusted to be the final minimum required duration, and the aperiodic task may be activated within the time budget based on the finish-to-activate duration.

### FIELD OF THE DISCLOSURE

This disclosure relates generally to computer systems, and, more particularly, to methods and apparatus to facilitate efficient scheduling of digital tasks in a system.

### BACKGROUND

Computer-driven programs and other processes can be implemented as a sequence of tasks executed serially and/or in parallel using one or more processors. In some cases, tasks occur at regular intervals; that is, some tasks are periodic. In other cases, tasks occur irregularly; that is, these other tasks are aperiodic. These periodic and aperiodic tasks are scheduled to be completed by a computer system processor to execute the overarching program to which the tasks belong.

### SUMMARY

An example method to schedule tasks includes identifying a periodic task; identifying an aperiodic task; determining an initial minimum required duration based on the periodic and aperiodic tasks; determining a finish-to-activate duration of the aperiodic task; determining a final minimum required duration based on the initial minimum required duration and the finish-to-activate duration; adjusting a time budget to be the final minimum required duration; and activating the aperiodic task within the time budget based on the finish-to-activate duration.

An example apparatus to schedule tasks includes a processor and a memory. The processor and the memory include instructions which, when executed, cause the processor to: identify a periodic task; identify an aperiodic task; determine an initial minimum required duration based on the periodic and aperiodic tasks; determine a finish-to-activate duration of the aperiodic task; determine a final minimum required duration based on the initial minimum required duration and the finish-to-activate duration; adjust a time budget to be the final minimum required duration; and activate the aperiodic task within the time budget based on the finish-to-activate duration.

An example tangible computer readable storage medium includes computer readable instructions which, when executed, cause a processor to at least: identify a periodic task, identify an aperiodic task, determine an initial minimum required duration based on the periodic and aperiodic tasks, determine a finish-to-activate duration of the aperiodic task, determine a final minimum required duration, adjust a time budget to be the final minimum required duration, and activate the aperiodic task within the time budget based on the finish-to-activate duration.

### BRIEF DESCRIPTION OF THE DRAWINGS

FIG. 1 is a diagram of example tasks of an application partition scheduled to be completed in accordance with the teachings of this disclosure.

FIG. 2 is a block diagram of an example environment in accordance with the teachings of this disclosure.

FIG. 3 is a more detailed block diagram of an example analyzer to implement the environment of FIG. 2 in accordance with the teachings of this disclosure.

FIG. 4 is a more detailed block diagram of an example minimum required duration determiner to implement the example analyzer of FIG. 3 in accordance with the teachings of this disclosure.

FIG. 5 is a more detailed block diagram of an example initial calculator to implement the example minimum required duration determiner of FIG. 4 in accordance with the teachings of this disclosure.

FIG. 6 is a more detailed block diagram of an example final calculator to implement the example minimum required duration determiner of FIG. 4 in accordance with the teachings of this disclosure.

FIG. 7 is a more detailed block diagram of an example schedulability verifier to implement the example analyzer of FIG. 3 in accordance with the teachings of this disclosure.

FIG. 8 is a more detailed block diagram of an example scheduler to implement the example environment of FIG. 2 in accordance with the teachings of this disclosure.

FIG. 9 is a more detailed block diagram of an example arrangement of the example finish-to-activate determiner of FIG. 3 in accordance with the teachings of this disclosure.

FIG. 10 is a more detailed block diagram of an alternative example arrangement of the finish-to-activate determiner of FIG. 3 in accordance with the teachings of this disclosure.

FIG. 11 is a more detailed block diagram of a further alternative example arrangement of the finish-to-activate determiner of FIG. 3 in accordance with the teachings of this disclosure.

FIG. 12 is a table illustrating example finish-to-activate values and corresponding minimum required duration values.

FIG. 13 is a table illustrating a finer resolution of the table of FIG. 12.

FIG. 14 is a flowchart representative of example machine readable instructions which may be executed to implement the environment of FIG. 2 to schedule partition tasks.

FIG. 15 is a flowchart representative of example machine readable instructions which may be executed to implement the environment of FIG. 2 to schedule partition tasks.

FIG. 16 is a flowchart representative of example machine readable instructions which may be executed to implement the environment of FIG. 2 to schedule partition tasks.

FIG. 17 is a flowchart representative of example machine readable instructions which may be executed to implement the environment of FIG. 2 to schedule partition tasks.

FIG. 18 is a flowchart representative of example machine readable instructions which may be executed to implement the environment of FIG. 2 to schedule partition tasks.

FIG. 19 is a flowchart representative of example machine readable instructions which may be executed to implement the environment of FIG. 2 to schedule partition tasks.

FIG. 20 is a flowchart representative of example machine readable instructions which may be executed to implement the environment of FIG. 2 to schedule partition tasks.

FIG. 21 is a flowchart representative of example machine readable instructions which may be executed to implement the environment of FIG. 2 to schedule partition tasks.

FIG. 22 is a block diagram of an example computer capable of executing the instructions of FIGS. 14-17 to implement the apparatus of FIGS. 3-11.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings. Wherever possible, the same reference numbers will be used throughout the drawing(s) and accompanying written description to refer to the same or like parts.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Multiple applications, programs, and/or other processes executing on a computer system may involve the same processor (e.g., the applications and/or their constituent tasks may each execute on a limited number of one or more processors). In some examples, applications may generate processes. Further, in some examples, processes may involve multiple threads of execution and the threads may involve one or more tasks to be executed by available processing resources. In some examples, there may be more applications demanding execution than available processors; therefore, the applications and/or their constituent tasks may share at least one processor. For example, computing tasks executing on a system may take turns with one another for time on a single processor. More specifically, to share a processor, the applications may be allocated periods of time on the processor, referred to as partitions. The partition may be allocated a set amount of contiguous time to execute, referred to as a partition budget or, additionally and alternatively, as a partition duration or as a window. Further, partitions may occur periodically (e.g., a period of the partition may be a measure of elapsed time between successive execution commencements of the application). It should be understood that a partition's budget, in some examples, may be less than or equal to the partition's period. As an example analogy for the relationship between partition budget and partition period, morning occurs periodically once per day, but does not last the entire day. In some examples, partitions are scheduled according to a rate monotonic scheduling (RMS) policy where tasks may be assigned static priorities according to respective task periods (e.g., a shorter task period may result in a higher priority and vice versa). Thus, application partitions may occur cyclically and applications may execute within partition budgets. Application tasks executed during partitions can include tasks to monitor and/or control equipment, such as aircraft or spacecraft, industrial process, such as power generation and/or distribution systems, etc.

A partition may have multiple tasks scheduled to be executed by the processor to perform a program or process, referred to collectively as a task system. Some of these tasks may happen regularly (e.g., the tasks are periodic tasks). Other tasks may happen irregularly (e.g., the tasks are aperiodic tasks). Additionally, some tasks may be more important to the program than others; therefore, the tasks may be prioritized. In some examples, tasks are statically prioritized. In some examples, tasks are dynamically prioritized. Task type and priority can impact a task's execution by a computer processing system. Periodic tasks can be scheduled according to a period or a deadline, ordered, in some examples, according to priority. In some examples, where the periods of periodic tasks are integer multiples of one another, the task system may be referred to as harmonic. Aperiodic tasks can be scheduled in between periodic tasks as the aperiodic tasks occur, for example. It should be understood that different task systems may have different tasks and that different partitions may therefore have different schedules and partition budgets.

In some examples, under static task prioritization, a particular application may accomplish all of its tasks scheduled in a particular partition within the particular partition's budget. In other examples, under static task prioritization, a particular application may accomplish its tasks spread over multiple partition instances. That is, the particular application may not complete all of its tasks within a given partition budget, so tasks may recommence to execute in a subsequent partition instance. Thus, it should be understood and appreciated that efficient scheduling of statically prioritized application tasks in partition instances may allow applications to execute more quickly. Put another way, the more tasks a particular application can fit into each of its partition budgets while still following static prioritization and timing requirements of the tasks, the more quickly the particular application will accomplish all its tasks. That is, efficiently ordering statically prioritized tasks may allow a particular application to complete more tasks working under a time constraint in a shared processing environment.

Example methods, apparatus, and articles of manufacture disclosed herein enable a computer system to analyze application tasks to optimize the utilization of system time. In particular, example methods, apparatus, and articles of manufacture disclosed herein determine finish-to-activate times of aperiodic tasks of an application to efficiently schedule the aperiodic tasks amongst periodic tasks of the application in a partition of processor time associated with the application.

Certain examples determine schedulability of real-time systems (e.g., aircraft systems, power systems, etc.). The terms “schedulability” and “schedulable” refer to analyses that determine whether a task system may be scheduled in a given partition so that no task ever misses its deadline. Task systems found to be schedulable may be referred to as “safe.” Safe scheduling helps to ensure that timing requirements (e.g., deadlines) are satisfied. Efficient scheduling optimizes and/or otherwise improves utilization of a system time budget to help achieve a better response time performance.

Certain examples consider both periodic tasks and aperiodic tasks. For an aperiodic task, certain examples provide a new activation mechanism based on a finish-to-activate (FTA) time between consecutive jobs of the aperiodic task. For safety-related analysis, certain examples determine a minimum required duration (MRD) of the system with respect to timing requirements. For efficiency-related analysis, certain examples provide objective functions and methods to more efficiently utilize system time budget, including a pseudo-periodic analysis based method, sequential minimization based method, and efficient frontier based method, for example.

Certain examples model and analyze a real-time system including both periodic and aperiodic tasks and determine a minimal amount of processing time required for the real-time system to guarantee schedulability requirements. Certain examples implement a systematic process to control activation of aperiodic tasks safely and efficiently by determining design variable(s) (e.g., finish-to-activate time(s)) to activate the aperiodic tasks.

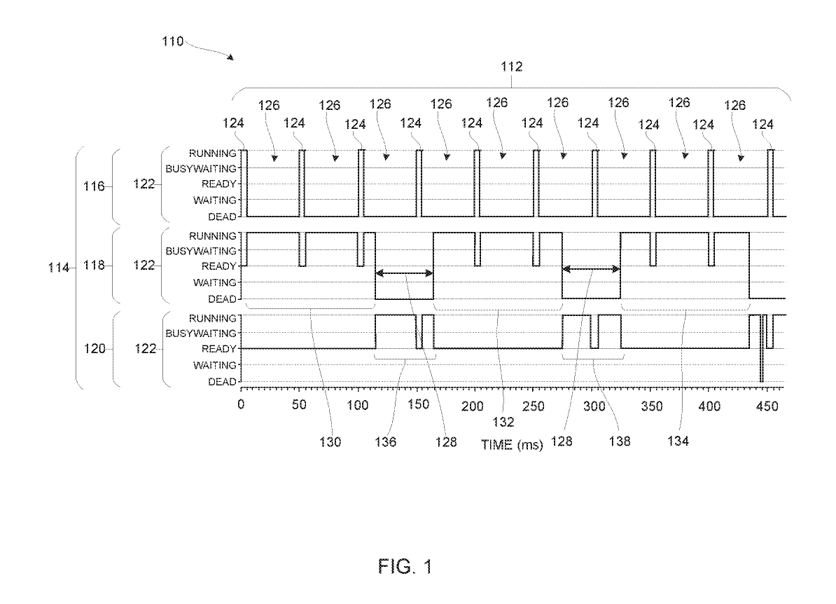

FIG. 1 is a graphical representation of a partition 110 using a finish-to-activate scheduling technique. More specifically, the partition 110 may have a time budget 112 as depicted in FIG. 1. As an example, partition 110 may include tasks 114. As a further example, the tasks 114 may include a periodic task 116 and first and second aperiodic tasks 118, 120. Further, as in the example of FIG. 1, first aperiodic task 118 may have a static higher priority than second aperiodic task 120. Additionally, tasks 114 may each have execution states 122. For example, the execution states 122 may include a running state, a busy waiting state, a ready state, a waiting state, and a dead state. As shown in the example of FIG. 1, periodic task 116 is active every 50 milliseconds (ms) for a duration of 5 ms. In the example of FIG. 1, first and second aperiodic tasks 118, 120 may therefore have 45 ms between every periodic job 124 of periodic task 116 to execute. Said differently, as illustrated in FIG. 1, first and second aperiodic tasks 118, 120 may have a duration or time period 126 of 45 ms in which to execute without interfering with the execution of periodic task 116. First and second aperiodic tasks 118, 120 may therefore be in competition to execute during these time periods 126.

To efficiently execute the first and second aperiodic tasks 118, 120 amongst the periodic task 116 while adhering to the differing priorities of the first and second aperiodic tasks 118, 120, the first and second aperiodic tasks 118, 120 may be scheduled according to a finish-to-activate duration 128, illustrated with arrows in FIG. 1. Put another way, scheduling the first and second aperiodic tasks 118, 120 per the finish-to-activate duration 128 may allow the first and second aperiodic tasks 118, 120 to execute whenever the first and second aperiodic tasks 118, 120 have a chance to do so according to the periodic task 116 while also acknowledging the different priority ranks of the first and second aperiodic tasks 118, 120. More specifically, as shown in the example of FIG. 1, the finish-to-activate duration 128 assigned to first aperiodic task 118 may be 50 ms. Further, as depicted in the example of FIG. 1, the first aperiodic task 118 may have successive jobs 130, 132, 134 each lasting 110 ms. Additionally, as also shown in the example of FIG. 1, second aperiodic task 120 may have successive jobs 136, 138.

In the example of FIG. 1, as the tasks 114 of the partition 110 progressively execute during the allocated time budget 112, the higher priority first aperiodic task 118 may execute during the time periods 126 when the periodic task 116 is inactive until the job 130 is complete, leaving the job 136 of the lower priority second aperiodic task 120 free to execute during the time periods 126 around the periodic task 116 until the finish-to-activate duration 128 is elapsed, at which point the first aperiodic task 118 is reactivated to perform job 132. Further, as shown in the example of FIG. 1, the first and second aperiodic tasks 118, 120 may continue to reactivate and deactivate according to the finish-to-activate duration 128 to respectively execute the jobs 134, 138 when the processor is available.

In some examples, when scheduling tasks 114 according to the finish-to-activate duration 128, the jobs 130, 132, 134 of the first aperiodic task 118 are separated by at least the finish-to-activate duration 128, thus allowing the second aperiodic task 120 time to execute. However, it should be understood that, in other examples, when scheduling tasks 114 per the finish-to-activate duration 128, the first aperiodic task 118 may execute at any point after the finish-to-activate duration has elapsed.

Thus, under a finish-to-activate scheduling approach, the higher priority first aperiodic task 118 may give the lower priority second aperiodic task 120 at least the finish-to-activate duration 128 to execute, but the higher priority first aperiodic task 118 may preempt the lower priority second aperiodic task 120 at any time once the finish-to-activate duration 128 has expired. That is, the finish-to-activate duration 128 may prevent the first aperiodic task 118 from activating again too soon after finishing. For example, the finish-to-activate duration 128 may cause the higher priority first aperiodic task 118 to wait for the finish-to-activate duration 128 to elapse between when the first aperiodic task 118 completes execution and when the first aperiodic task 118 reactivates for another execution.

Therefore, it should be understood that the finish-to-activate duration 128 may be an imposed waiting time period between a first time at which a particular higher priority aperiodic task finishes and a second time at which the particular higher priority aperiodic task may be permitted to execute again using available processing resources. Thus, the imposed waiting time periods enacted through finish-to-activate scheduling provide fairness to lower-priority aperiodic tasks by preventing the over-domination of processing resources by higher-priority aperiodic tasks while simultaneously recognizing the status of periodic tasks and higher-priority aperiodic tasks over lower-priority aperiodic tasks.

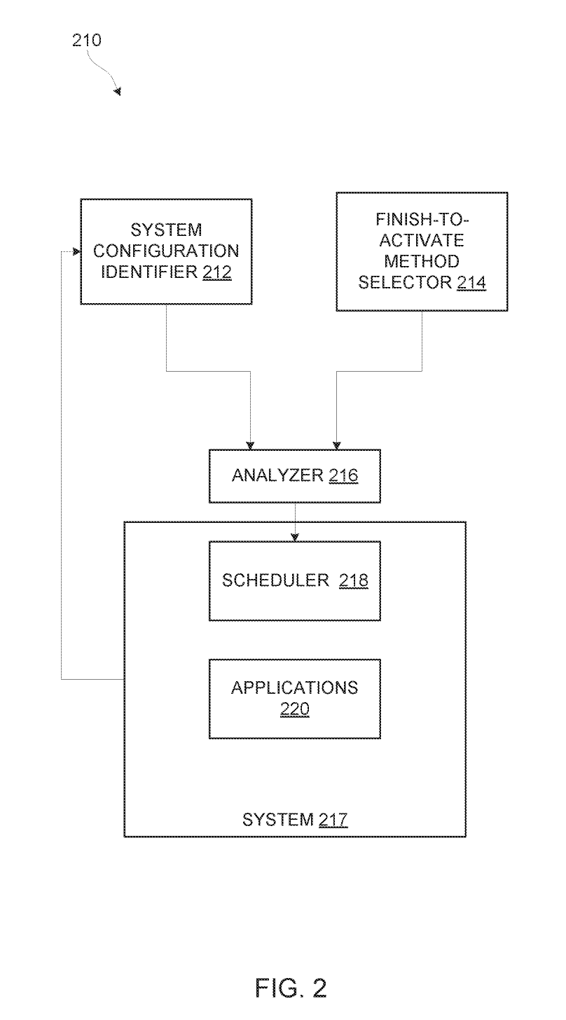

It should be understood that FIG. 1 is an example of finish-to-activate scheduling. It should be understood that a partition of an application may have any number of periodic and aperiodic tasks scheduled to execute in the partition, a partition may have any period, a partition may have any budget, a finish-to-active duration may be of any duration, periodic tasks may have any period, periodic and aperiodic tasks may have any execution duration, periodic and aperiodic tasks may have any number of jobs, and any number of aperiodic tasks may be scheduled with a respective finish-to-activate duration. Example methods and apparatus to implement finish-to-activate scheduling are described below in conjunction with FIGS. 2-19.

Turning to FIG. 2, an environment 210 may include a system configuration identifier 212, a finish-to-activate method selector 214, an analyzer 216, and a system 217. The system 217 may include a scheduler 218 and one or more applications 220. In some examples, the environment 210 is included in a single computer. In some examples, the system 217 is included in one or more computers that are separate from one or more computers that include the system configuration identifier 212, the finish-to-activate method selector 214, and the analyzer 216. Further, it should be understood that the system configuration identifier 212, the finish-to-activate method selector 214, and the analyzer 216 may perform finish-to-activate scheduling analysis offline of the system 217.

In the illustrated example, the system configuration identifier 212 may identify the applications 220 and tasks of applications 220 that execute in the system 217. In some examples, the system configuration identifier 212 may identify local-time tasks (e.g., a high frequency system timer in the system 217). The system configuration identifier 212 also may identify a particular partition of a particular application of the system 217 for finish-to-activate scheduling analysis. The system configuration identifier 212 may identify a period of the partition under consideration. The system configuration identifier 212 additionally may identify global-time tasks of the particular partition under consideration. The system configuration identifier 212 may identify the respective periods, execution times, deadlines, and priorities of the local-time tasks and of the global-time tasks. It should be understood that the periods of local-time tasks are specified with respect to the partition under consideration (e.g., time does not progress when the partition to which the local-time task belongs is not active). It also should be understood that the periods of global-time tasks are specified with respect to time in general (e.g., time is elapsing even when the partition to which the global-time task belongs is not active). Further, the system configuration identifier 212 may identify which of the tasks, both global and local-time, are periodic and which are aperiodic. Thus, in some examples, a given task may be a periodic global-time task, an aperiodic global-time task, a periodic local-time task, or an aperiodic local-time task.

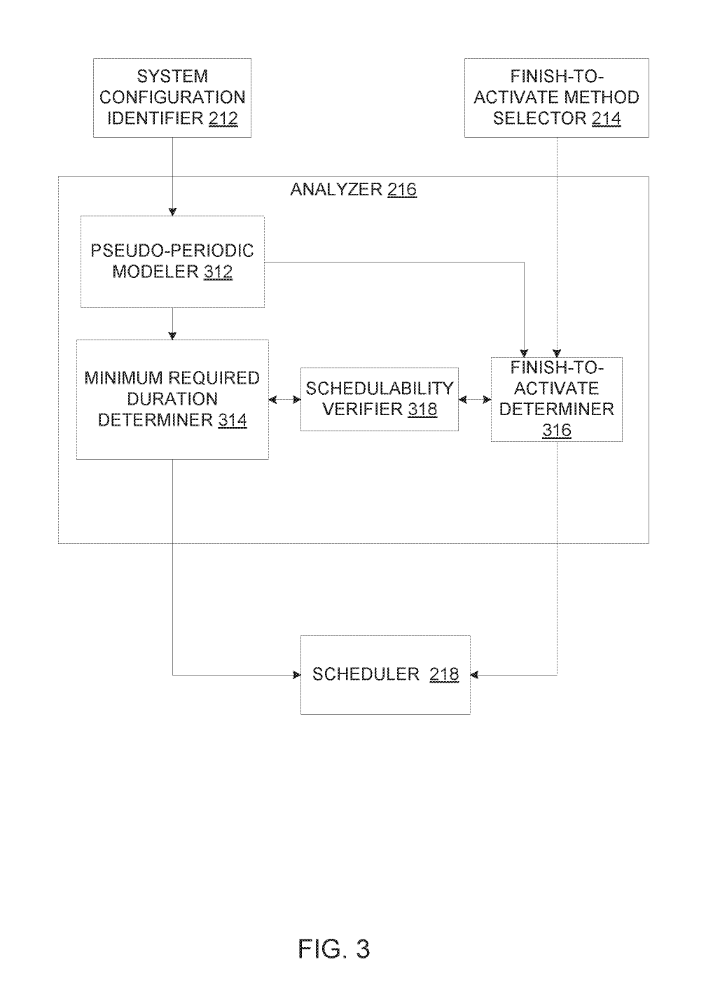

The finish-to-activate method selector 214 may select a finish-to-activate scheduling analysis method. Finish-to-activate scheduling analysis methods may be objective functions including, for example, pseudo-periodic analysis, sequential minimization analysis, and frontier map analysis. The example objective functions will be described in greater detail below in conjunction with FIGS. 3-22. The finish-to-activate method selector 214 may inform the analyzer 216 of the selected finish-to-activate scheduling analysis method.

The analyzer 216 may analyze the identified tasks of the partition under consideration. Further, the analyzer 216 may determine a finish-to-activate duration for an aperiodic task of the partition under consideration. Additionally, the analyzer 216 may determine a final minimum required duration for the partition under consideration. The final minimum required duration may be the least amount of time sufficient for the scheduled tasks of the partition under consideration to execute under finish-to-activate scheduling, for example. In certain examples, the final minimum required duration may be the smallest budget needed when the respective application tasks assigned to the partition are to be fit into the partition using finish-to-activate scheduling. The analyzer 216 may send the finish-to-activate duration and the final minimum required duration to the scheduler 218. In some examples, the analyzer 216 sends the finish-to-activate duration and the final minimum required duration to the scheduler 218 as a configuration. The scheduler 218 may cause the partition to execute according to the finish-to-activate duration and the final minimum required duration. Example methods and apparatus to determine the finish-to-activate duration and the final minimum required duration are discussed in greater detail below in conjunction with FIGS. 3-19.

Referring to FIG. 3, the analyzer 216 of FIG. 2 may include a pseudo-periodic modeler 312, a minimum required duration determiner 314, a finish-to-activate determiner 316, and a schedulability verifier 318.

The pseudo-periodic modeler 312 may receive identified task information about the partition from the system configuration identifier 212. The pseudo-periodic modeler 312 may respectively generate a pseudo-periodic model of any aperiodic task included in the received task information. More specifically, in some examples, the pseudo-periodic models generated by the pseudo-periodic modeler 312 may have a period equal to a predetermined deadline of the respective aperiodic task.

The minimum required duration determiner 314 may receive the task information about the partition under consideration, including any generated pseudo-periodic models, by way of the pseudo-periodic modeler 312. Additionally, the minimum required duration determiner 314 may use the task information received from the pseudo-periodic modeler 312 to generate an initial minimum required duration (e.g., budget) of the partition under consideration. It should however be understood that the initial minimum required duration may be an analytical starting point to determining the final minimum required duration (e.g., the final minimum required duration may be found through further analysis using the initial minimum required duration). It should further be understood that the final minimum required duration may be the smallest budget possible for the partition under consideration using finish-to-activate scheduling. The minimum required duration determiner 314 may report the final minimum required duration to the scheduler 218. Further, the minimum required duration determiner may send the periodic task information, the partition period, and the initial minimum required duration to the schedulability verifier 318.

The finish-to-activate determiner 316 may receive the task information about the partition under consideration, including any generated pseudo-periodic models, via the pseudo-periodic modeler 312. Further, the finish-to-activate determiner 316 may use the task information and the pseudo-periodic model to generate a finish-to-activate duration for the aperiodic task. It should however be understood that, in some examples, the finish-to-activate duration may be a trial finish-to-activate duration (e.g., a definitive finish-to-activate duration may be found through further analysis using the trial finish-to-activate duration). The finish-to-activate determiner 316 may report the definitive finish-to-activate duration to the scheduler 218. Further, the finish-to-activate determiner 316 may send the aperiodic task information and the finish-to-activate duration to the schedulability verifier 318.

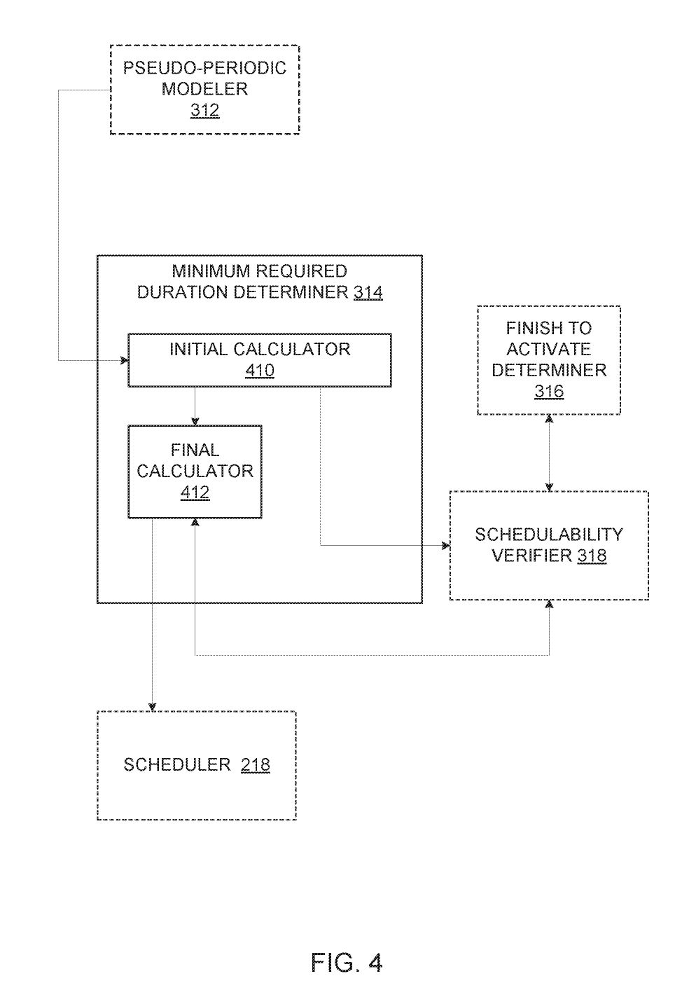

The schedulability verifier 318 may receive the initial minimum required duration, the partition period, and the periodic task information from the minimum required duration determiner 314. The schedulability verifier 318 also may receive the finish-to-activate duration and the aperiodic task information from the finish-to-activate determiner 316. The schedulability verifier 318 further may verify whether the tasks of the partition under consideration are schedulable according to the initial minimum required duration and finish-activate-duration. In some examples, the schedulability verifier 318 may request the minimum required duration determiner to iteratively produce budgets increased from the initial minimum required duration. In some examples, the schedulability verifier 318 may request the finish-to-activate determiner 316 to iteratively produce finish-to-activate durations increased from the trial finish-to-activate duration. In some examples, the schedulability verifier 318 may receive multiple finish-to-activate durations to verify against budgets supplied by the minimum required duration determiner 314. Example methods and apparatus to find the initial and final minimum required durations as well as the finish-to-activate duration are explained in more detail below with the aid of FIGS. 4-17.

Turning to FIG. 4, the minimum required duration determiner 314 may include an initial calculator 410 and a final calculator 412.

The initial calculator 410 may obtain task information, including any generated pseudo-periodic task models, from the pseudo-periodic modeler 312 (shown in phantom). Moreover, the initial calculator 410 may calculate the initial minimum required duration based on the information received from the pseudo-periodic modeler 312. The initial calculator 410 may send the initial minimum required duration to the final calculator 412 and the schedulability verifier 318.

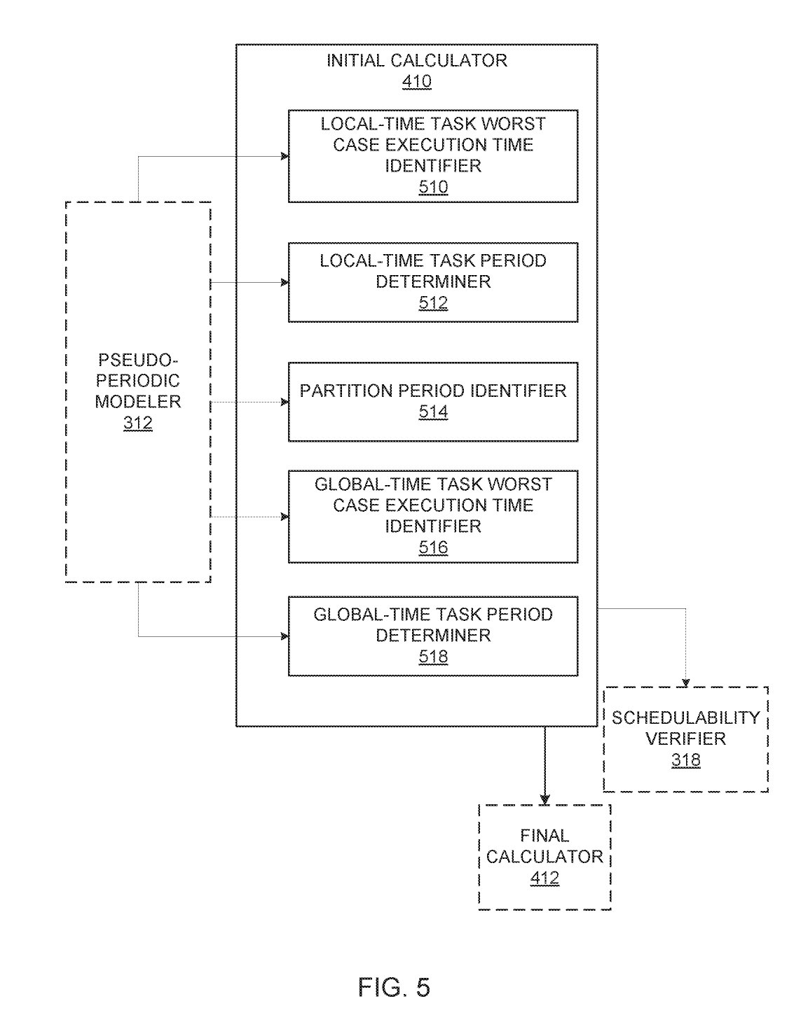

The final calculator 412 may receive the initial minimum required duration from the initial calculator 410 and the finish-to-activate duration from the finish-to-activate determiner 316 (shown in phantom). The final calculator 412 may produce budgets increased from the initial minimum required duration based upon requests from the schedulability verifier 318. Upon receiving a success report from the schedulability verifier 318, the final calculator 410 may mark the last increased budget produced as the final minimum required duration. The final calculator 412 may send the final minimum required duration to the scheduler 218. Example methods and apparatus to calculate the initial and final minimum required durations and the finish-to-activate duration are described in further detail below conjointly with FIGS. 5-22.

Focusing now on FIG. 5, the initial calculator 410 may include a local-time task worst case execution time identifier 510, a local-time task period determiner 512, a partition period identifier 514, a global-time task worst case execution time identifier 516, and a global-time task period determiner 518.

In some examples, where the periodic task and pseudo-periodic model are local-time tasks, the local-time task worst case execution time identifier 510 may receive task information via the pseudo-periodic modeler 312 (shown in phantom) to respectively identify predetermined worst case execution times of the periodic task and of the pseudo-periodic model.

In some examples, where the periodic task and pseudo-periodic model are local-time tasks, the local-time task period determiner 512 may receive task information from the pseudo-periodic modeler 312 to identify periods of the periodic task and of the pseudo-periodic model.

The partition period identifier 514 may receive information by way of the pseudo-periodic modeler 312 (shown in phantom) to identify a period of the partition under consideration.

In some examples, where the periodic task and pseudo-periodic model are global-time tasks, the global-time task worst case execution time identifier 516 may receive task information from the pseudo-periodic modeler 312 (shown in phantom) to identify predetermined worst case execution times of the period task and of the pseudo-periodic model.

In some examples, where the periodic task and pseudo-periodic model are global-time tasks, the global-time task period determiner 518 may receive task information from the pseudo-periodic modeler 312 (shown in phantom) to determine periods of the period task and of the pseudo-periodic model.

Moreover, the initial calculator 410 may calculate the initial minimum required duration according to Equation 1, below, where eᵢ represents the respective predetermined worst case execution times of the global-time tasks, pᵢ represents the respective periods of the global-time tasks, P represents the period of the partition under consideration, eⱼ represents the respective predetermined worst case execution times of the local-time tasks, and pⱼ represents the respective periods of the local-time tasks.

$$initial minimum required duration = \frac{{\sum }_{i ∈ all global - time tasks} \frac{{e}_{i}}{\frac{{p}_{i}}{P}}}{1 - {\sum }_{j ∈ all local - time tasks} \frac{{e}_{j}}{{p}_{j}}} \qquad ( Equation 1 )$$

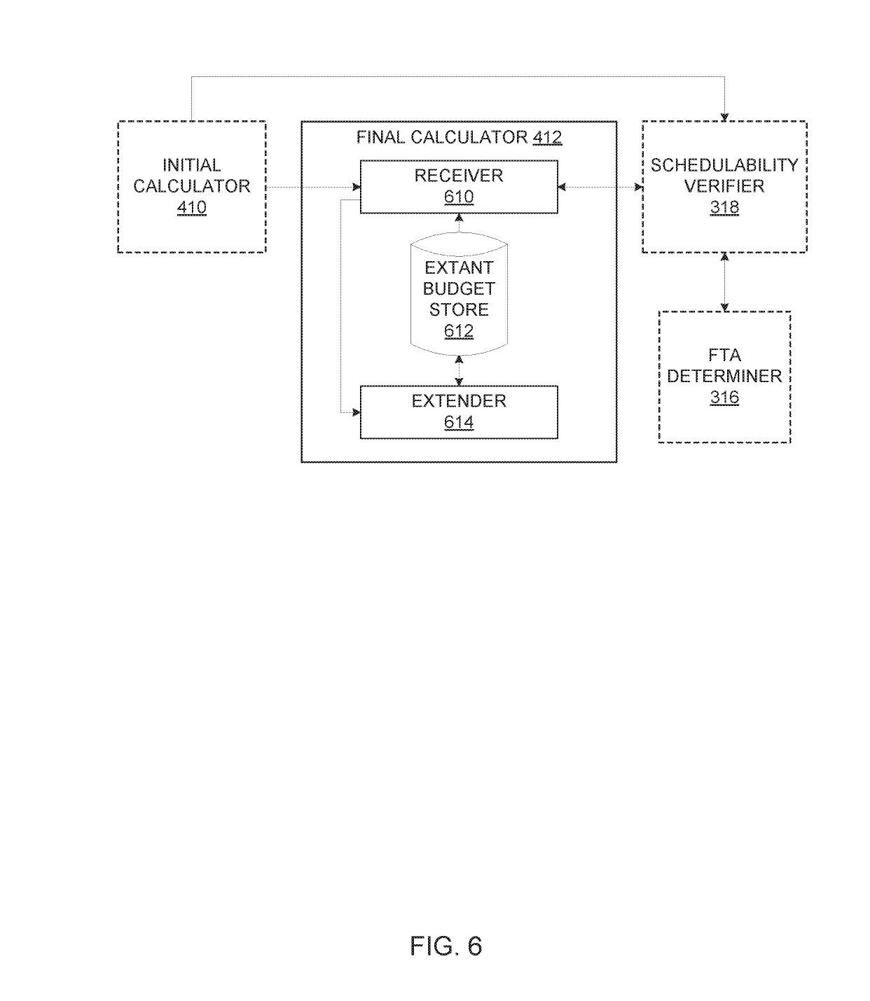

Thus, using Equation 1, the initial calculator 410 may yield the initial minimum required duration, which may be a value measured in units of time. In some examples, where the partition under consideration is harmonic (e.g., where, for a set of prioritized tasks sorted in increasing order, the period of a given task is an integer multiple of its immediately preceding task), the initial minimum required duration yielded by Equation 1 may be the final minimum required duration. In other examples, where the partition under consideration is inharmonic, the initial minimum required duration yielded by Equation 1 may be used in further finish-to-activate scheduling analyses by the final calculator 412 (shown in phantom) and the schedulability verifier 318 (shown in phantom) in finding the final minimum required duration and the finish-to-activate duration. Example methods and apparatus to determine the final minimum required duration and the finish-to-activate duration are discussed below with the help of FIGS. 6-17.

Turning to FIG. 6, the final calculator 412 may include a receiver 610, an extant budget store 612, and an extender 614.

The receiver 610 may receive the initial minimum required duration from the initial calculator 410 (shown in phantom). The receiver 610 may further store the received initial minimum required duration value in the extant budget store 612. The receiver 610 may also receive requests from the schedulability verifier 318 for the final calculator to add time to the initial minimum required duration supplied to the schedulability verifier 318 by the initial calculator 410. Put another way, via the receiver 610, the schedulability verifier 318 may ask the final calculator to provide a budget that may be increased from the initial minimum required duration. Additionally, the receiver 610 may send the requests from the schedulability verifier 318 to the extender 614. Further, the receiver 610 may retrieve increased budgets from the extant budget store 612 and may return the increased budgets to the schedulability verifier 318.

The extant budget store 612 may store budget values, particularly the initial minimum required duration and any updated budgets provided by the extender 614.

The extender 614 may receive the requests from the schedulability verifier 318 via the receiver 610. The extender 614 may retrieve the latest budget value from the extant budget store 612 and further may add time to the latest budget value to generate an increased budget. Additionally, the extender 614 may store the increased budget in the extant budget store 612.

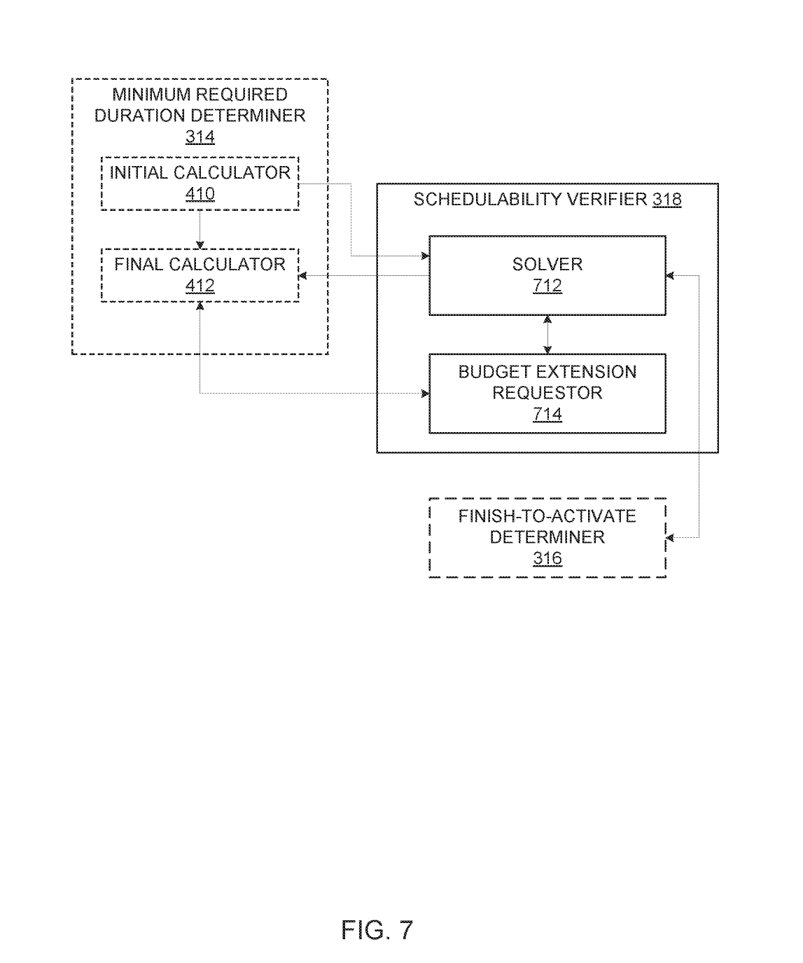

It should be understood and appreciated that the increased budget may be the final minimum required duration in examples where the schedulability verifier 318 successfully finds a finish-to-activate duration solution. In other words, when the schedulability verifier 318 determines the definitive finish-to-activate duration, the latest increased budget generated by the extender 614 and stored in the extant budget store 612 may be renamed as the final minimum required duration. For example, the final minimum required duration may be the initial minimum required duration plus the cumulative time extensions added by the extender 614 (at the request of the schedulability verifier 318) when the schedulability verifier 318 verifies that the partition is schedulable using the finish-to-activate duration supplied by the finish-to-activate determiner 316 and a budget equal to the initial minimum required duration plus the cumulative time extensions. Example methods and apparatus for determining the finish-to-activate duration are described in greater detail below in conjunction with FIGS. 7-19.

Turning to FIG. 7, the schedulability verifier 318 may include a solver 712, and a budget extension requestor 714.

The solver 712 may search for a finish-to-activate solution by attempting to resolve the periodic and aperiodic tasks of the partition under consideration into the budget stored in the extant budget store 612 of the final calculator 412 with respect to the finish-to-activate duration provided by the finish-to-activate determiner 316. Rephrased, the solver 712 may find a way to arrange the aperiodic and periodic tasks of the partition under consideration so that the aperiodic task executes according to priority and to the finish-to-activate duration and so that the aperiodic and periodic tasks fit into the latest updated budget held in the extant budget store 612 of the final calculator 412. For example, the solver 712 may attempt to resolve the partition under consideration's tasks into the extant budget store's 612 latest duration or time budget while obeying task priorities and finish-to-activate determiner 316-provided finish-to-activate durations.

In cases where the solver 712 successfully resolves the aperiodic and periodic tasks into the budget, thus making a finding that the provided finish-to-activate duration and the extant budget are compatible, the solver 712 may send the successful compatibility finding to the final calculator 412. It should be understood that the compatible finish-to-activate duration and the extant budget together may be referred to as the finish-to-activate solution. It should therefore be understood that the extant budget of the finish-to-activate solution may be referred to as the final minimum required duration.

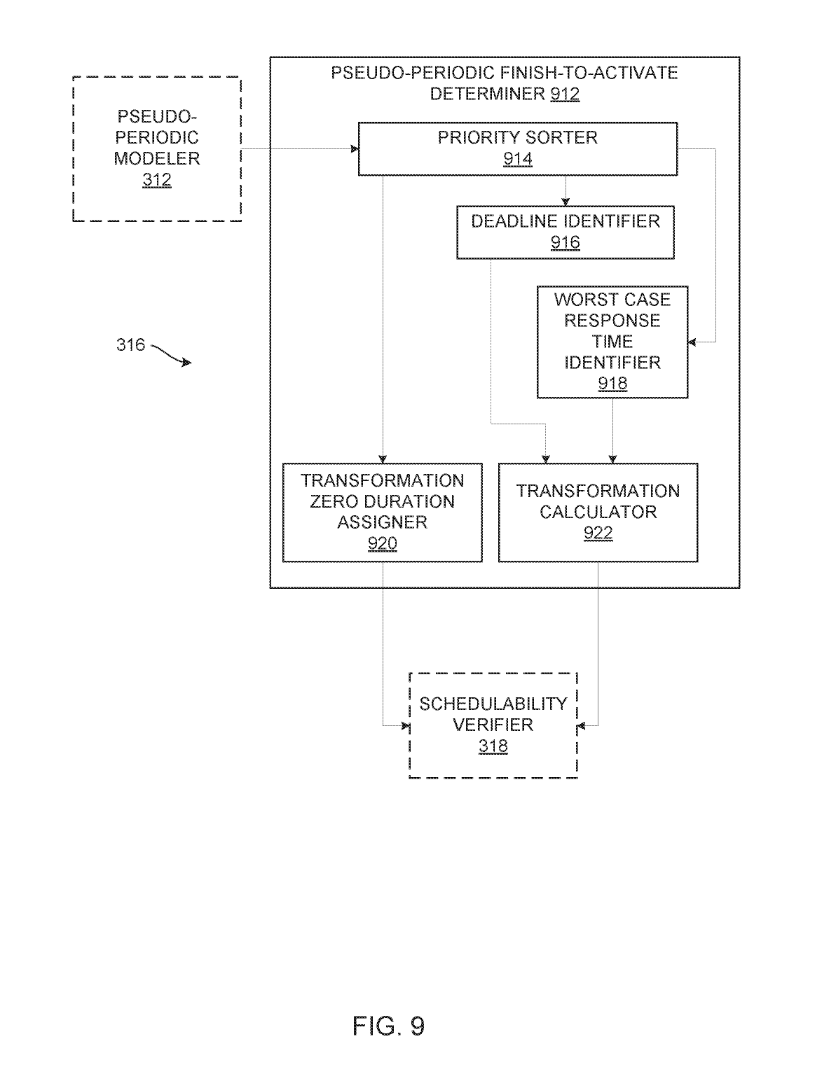

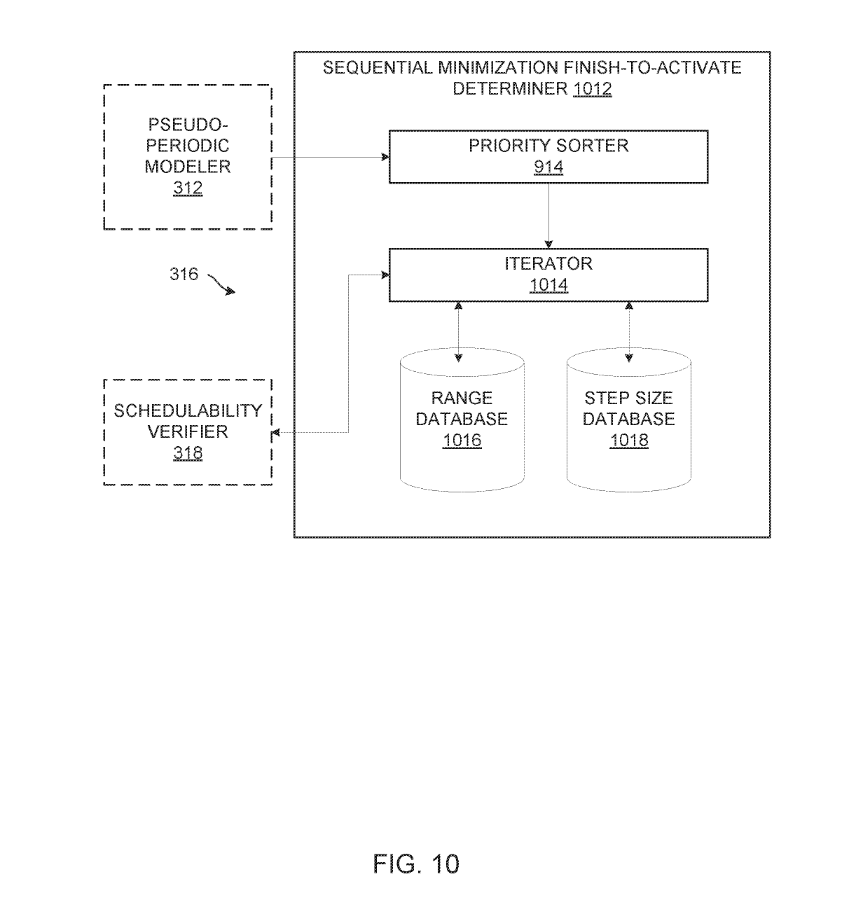

In cases where the solver 712 fails to resolve the aperiodic and periodic tasks into the extant budget, thus making a determination that the provided finish-to-activate duration and the extant budget are incompatible, the solver 712 may send the determination to the budget extension requestor 714. In some examples, to be described below with the aid of FIGS. 9 and 14-16, where the provided finish-to-activate duration and the extant budget are found incompatible, the solver 712 may send the incompatibility determination to the budget extension requestor 714 after a single resolve attempt with the provided finish-to-activate duration. In other examples, to be further explained below in conjunction with FIGS. 10-15 and 17-19, where the provided finish-to-activate duration and the extant budget are found incompatible, the solver 712 may attempt to resolve according to multiple finish-to-activate determiner 316-provided finish-to-activate durations before the solver 712 sends the incompatibility determination to the budget extension requestor 714.

The budget extension requestor 714 may receive the incompatibility determination from the solver 712. Further, the budget extension requestor 714 may send a request to the final calculator 412 asking that the final calculator 412 return an increased budget. Additionally, the budget extension requestor 714 may send the returned increased budget to the solver 712.

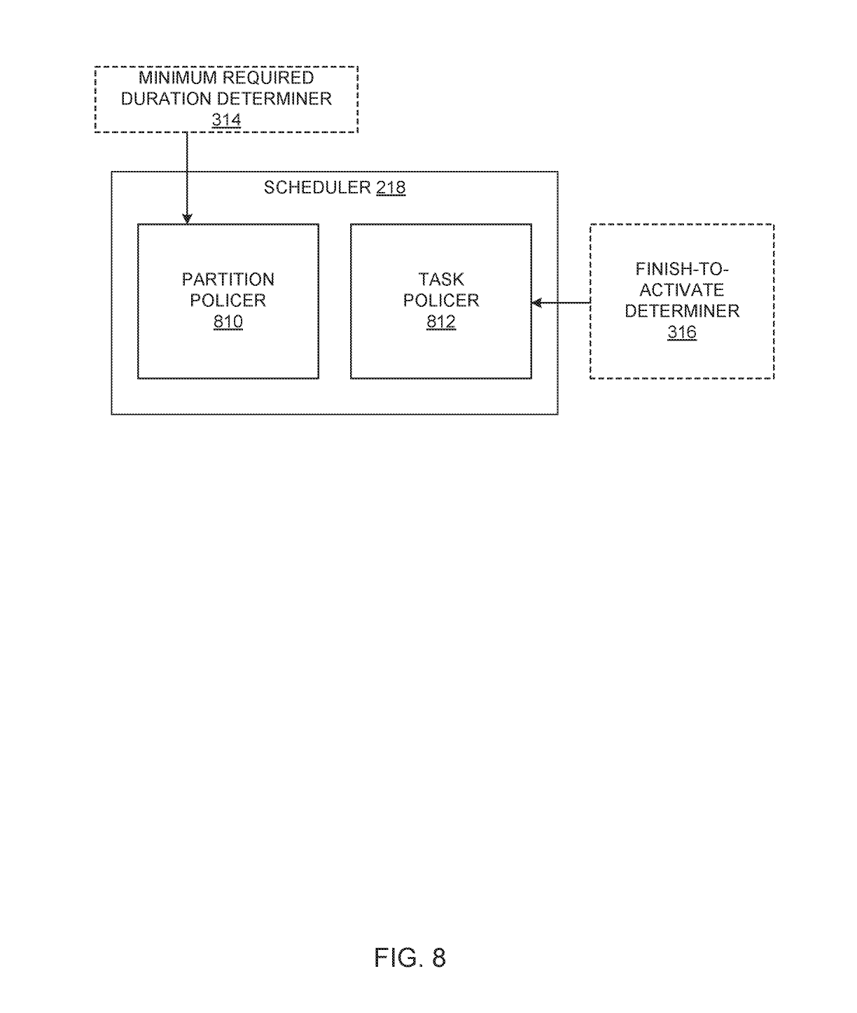

Returning to FIG. 3, in light of the above description of FIGS. 4-7, it should be appreciated that the minimum required duration determiner 314, the schedulability verifier 318, and the finish-to-activate determiner 316 may work together to find the finish-to-activate solution. In other words, the minimum required duration determiner 314, the schedulability verifier 318, and the finish-to-activate determiner 316 may cooperate to find the final minimum required duration and the finish-to-activate duration that are compatible with one another. Example structures and methods to implement the determined final minimum required duration and the finish-to-activate duration are described below in conjunction with FIGS. 8 and 14-19.

Turning now to FIG. 8, the scheduler 218 may include a partition policer 810 and a task policer 812.

The partition policer 810 may receive the final minimum required duration from the minimum required duration determiner 314 (shown in phantom). Further, the partition policer 810 may adjust a time period associated with the partition (e.g., the budget) under consideration to be the final minimum required duration. Put another way, the partition policer 810 may set the budget of the partition under consideration to be equal to the final minimum required duration.

The task policer 812 may receive the finish-to-activate duration from the finish-to-activate determiner 316. Additionally, the task policer 812 may police the partition under consideration to activate the aperiodic task based on the finish-to-activate duration. It again should be understood and appreciated that the partition under consideration may have multiple aperiodic tasks, each with a respective finish-to-activate duration. Further, it should be understood that an aperiodic task may have a finish-to-activate duration greater than the budget of a particular partition in which the aperiodic task executes. That is, in some examples, a particular finish-to-activate duration may thus schedule a particular aperiodic task to execute in certain instances of a partition and, in other examples, to skip other instances of the partition. Rephrased, the task policer 812 may cause each aperiodic task of the partition under consideration to execute according to the respective finish-to-activate duration of the aperiodic task.

Thus, as shown in FIGS. 2-3, it should be understood that the scheduler 218 may receive the finish-to-activate solution from the analyzer 216, specifically from the minimum required duration determiner 314 and the finish-to-activate determiner 316, and also may impose finish-to-activate scheduling on the partition under consideration based on the finish-to-activate solution. Further, it should be understood, that by using the analyzer 216 to produce finish-to-activate solutions for all the aperiodic tasks of a partition for the scheduler 218, the scheduler 218 may implement finish-to-activate scheduling across the partition. Example methods and more specific structures to determine the finish-to-activate solution are described in FIGS. 9-19.

Referring now to FIG. 9, in some examples, the finish-to-activate determiner 316 may be more precisely referred to as a pseudo-periodic finish-to-activate determiner 912.

The pseudo-periodic finish-to-activate determiner 912 may receive aperiodic task information from the pseudo-periodic modeler 312 (shown in phantom). Further, the pseudo-periodic finish-to-activate determiner 912 may include a priority sorter 914, a deadline identifier 916, a worst case response time identifier 918, a transformation zero duration assigner 920, and a transformation calculator 922. In examples where the partition under consideration includes multiple aperiodic tasks, the priority sorter 914 may sort the aperiodic tasks according to respective predetermined priorities of the aperiodic tasks and may send the lowest priority aperiodic task to the transformation zero duration assigner 920. The deadline identifier 916 may identify a predetermined deadline of each aperiodic task. The worst case response time identifier 918 may identify a predetermined worst case response time of each aperiodic task. In some examples, worst case response times may be precomputed via the analyzer 216 using a simulation-based method and/or a validation-based method. The transformation zero duration assigner 920 may assign the lowest priority (e.g., the least important) aperiodic task with a finish-to-activation duration of zero to transform the lowest priority aperiodic task from the pseudo-periodic model to finish-to-activate based activation. Moreover, the transformation calculator 922 may calculate respective finish-to-activate durations for each—except the lowest priority—aperiodic task of the partition under consideration according to Equation 2, below, where FTAᵢ, Deadlineᵢ, and WCRTᵢ respectively represent the finish-to-activate duration, the deadline, and the worst case response time of a particular aperiodic task. The transformation calculator 922 thus may transform the higher priority aperiodic tasks from pseudo-periodic models to finish-to-activate based activation.

FTAᵢ=Deadlineᵢ−WCRTᵢ (Equation 2)

Thus, the pseudo-periodic finish-to-activate determiner 912 may yield a single finish-to-activate duration for each respective aperiodic task of the partition under consideration based on respective predetermined characteristics of the aperiodic tasks. Further, the pseudo-periodic finish-to-activate determiner 912 may respectively assign the found finish-to-activate durations to the aperiodic tasks. Additionally, the pseudo-periodic finish-to-activate determiner 912 may send the assigned finish-to-activate durations to the schedulability verifier 318.

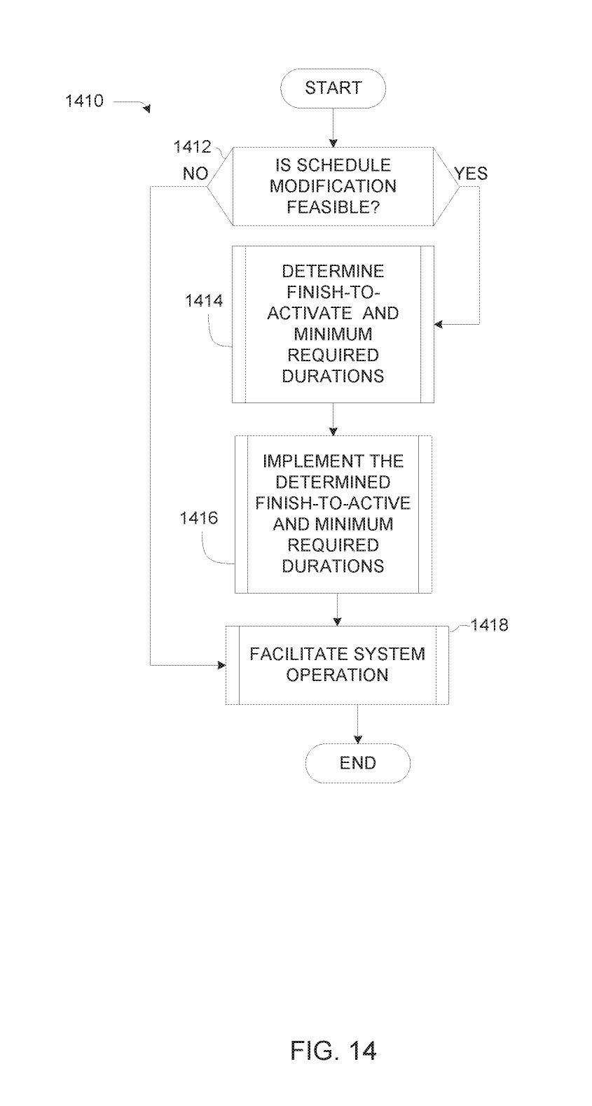

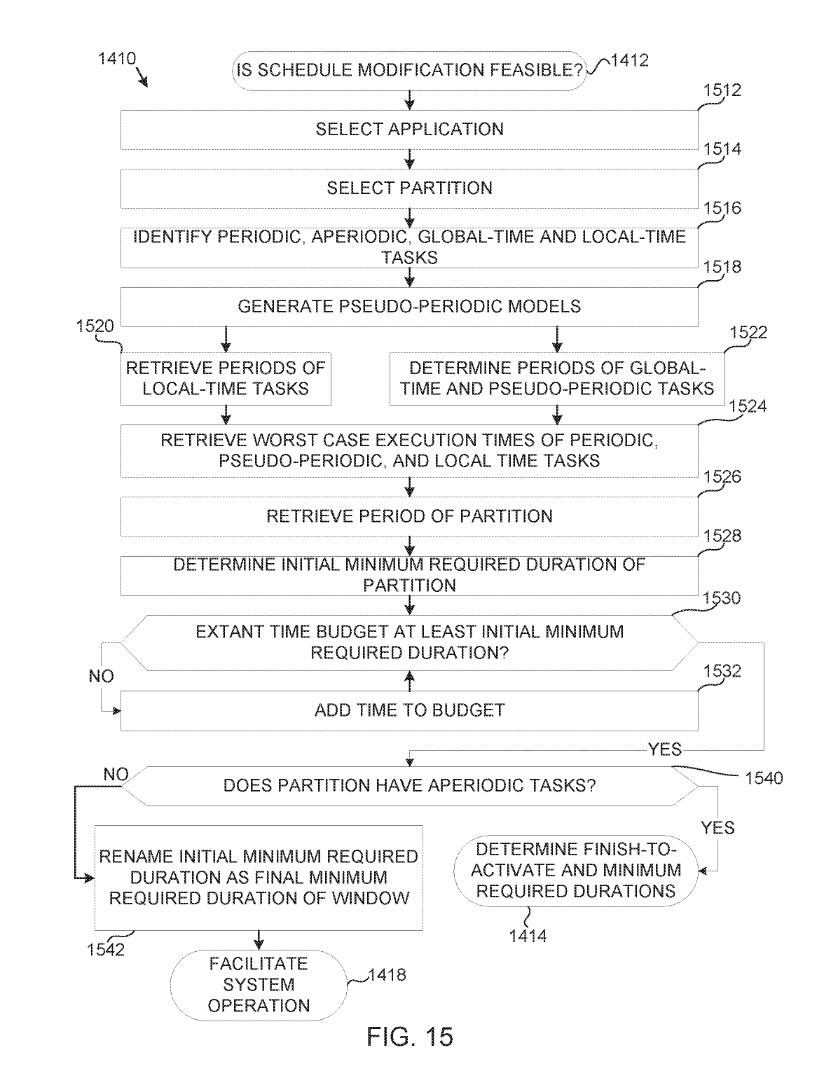

In some examples, the schedulability verifier 318 may attempt to schedule the periodic and aperiodic tasks into the extant budget held by the extant budget store 612 of FIG. 6 according to the assigned single finish-to-activate duration provided by the pseudo-periodic finish-to-activate determiner 912. It should be understood that the schedulability verifier 318 may seek a finish-to-activate solution using the assigned finish-to-activate duration as a set value, as opposed to a variable. Put another way, it should be understood that after receiving the assigned finish-to-activate value, the schedulability verifier 318 may work only with the final calculator 412 of FIGS. 4, 6, and 7 via the budget extension requestor 714, illustrated in FIG. 7, to find a finish-to-activate solution. Example methods to implement the structures of FIG. 9 are described below in conjunction with FIGS. 14-15.

Turning to the example of FIG. 10, the finish-to-activate determiner 316 may be more precisely referred to as a sequential minimization finish-to-activate determiner 1012.

The sequential minimization finish-to-activate determiner 1012 may receive aperiodic task information from the pseudo-periodic modeler 312 (shown in phantom). Further, the sequential minimization finish-to-activate determiner 1012 may include the priority sorter 914, an iterator 1014, a range database 1016, and a step size database 1018. As above, the priority sorter 914 may sort aperiodic tasks of the partition under consideration according to priority. The range database 1016 may store endpoints for a range of sample finish-to-activate duration values. As an example, the range endpoints may be 0 and 10 ms. The step size 1018 database may store a step size to be applied between the range endpoints. As another example, the step size may be 0.5 ms. The iterator 1014 may retrieve the range endpoints of sample finish-to-activate duration values from the range database 1016. The iterator 1014 may also retrieve the step size from the step size database 1018. Further, the iterator 1014 may apply the step size to the range endpoints to produce sequential sample finish-to-activate values. As another example following the previous two examples, the sequential sample finish-to-activate values may thus be 0, 0.5, 1, 1.5, 2, 2.5, . . . , 9, 9.5, 10 ms. Rephrased, the range endpoints stored by the range database 1016 may provide upper and lower termini for the sample finish-to-activate values and the step size stored by the step size database 1018 may provide increments for the sample finish-to-activate values. It should be understood that the lower range endpoint, the upper range endpoint, and step size may be any value. It should also be understood that the sample finish-to-activate values may thus also be any value. Moreover, the sequential minimization finish-to-activate determiner 1012 may iteratively provide the sample finish-to-activate values to the schedulability verifier 318.

In some examples, the schedulability verifier 318 may attempt to iteratively schedule the periodic and aperiodic tasks into the extant budget held by the extant budget store 612 of FIG. 6 according to the sample finish-to-activate duration iteratively provided by the sequential minimization finish-to-activate determiner 1012. Rephrased, the iterator 1014 may provide the schedulability verifier 318 the sample finish-to-activate values one-by-one for the schedulability verifier 318 to attempt to schedule the periodic and aperiodic tasks with respect to the extant budget and the sample finish-to-activate values. For example, the schedulability verifier 318 may consider one aperiodic task per iteration of sample finish-to-activate values provided by the iterator 1014 to search for a minimal finish-to-activate value for the aperiodic task with respect to the extant budget.

In some examples, where the schedulability verifier 318 cannot find a finish-to-activate solution, the schedulability verifier 318 may request the next sequential sample finish-to-activate value from the sequential minimization finish-to-activate determiner 1012 until the greatest sample finish-to-activate value, i.e., the range endpoint, is reached.

In some examples, where the schedulability verifier 318 has exhausted the sample finish-to-activate values, the schedulability verifier 318 may request the final calculator 412 of FIGS. 4, 6, and 7, via the budget extension requestor 714 of FIG. 7, to increase the extant budget. Once the final calculator 412 has returned the increased budget, the sequential minimization finish-to-activate determiner 1012 and the schedulability verifier 318 may restart the search for the finish-to-activate solution from the lowest sample finish-to-activate value (e.g., a beginning of the range of FTA duration values). In other words, the sequential minimization finish-to-activate determiner 1012 and the schedulability verifier 318 may respectively incrementally provide and work through the sample finish-to-activate values with respect to the extant budget until, absent finding the finish-to-activate solution, the sample finish-to-activate values are exhausted, at which point the schedulability verifier 318 may request an increased budget from the final calculator 412 of FIGS. 4, 6, and 7 via the budget extension requestor 714 of FIG. 7.

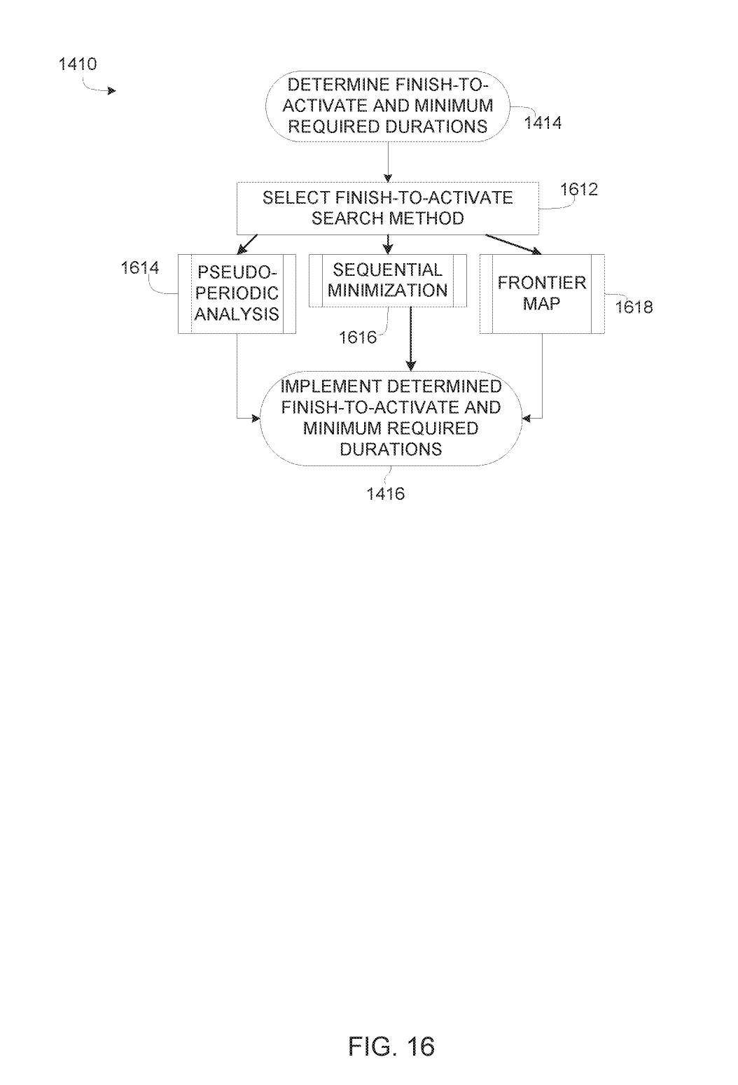

Once the minimal finish-to-activate value for the aperiodic task under consideration is found, the iterator 1014 may change the aperiodic task from its respective pseudo-periodic model to finish-to-activate based activation, and the iterator 1014 may move on to a next iteration. It should be understood that the sequential minimization finish-to-activate determiner 1012, the schedulability verifier 318, and the final calculator 412 of FIGS. 4, 6, and 7 may cooperate to iteratively find a finish-to-activate solution. Example methods to implement the structures of FIG. 10 are described below in conjunction with FIGS. 14 and 16.

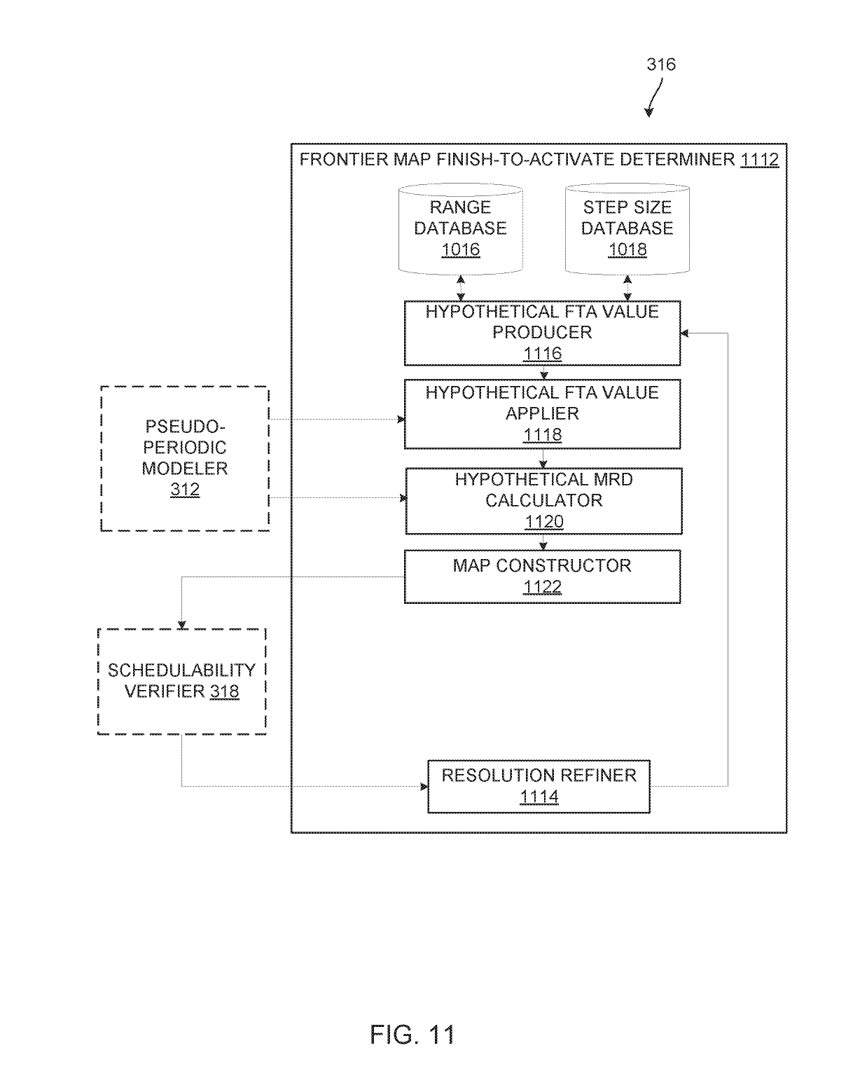

Turning to the examples of FIGS. 11-13, the finish-to-activate determiner 316 may be more precisely referred to as a frontier map finish-to-activate determiner 1112. In some examples, the frontier map finish-to-activate determiner 1112 includes the range database 1016, the step size database 1018, a resolution refiner 1114, a hypothetical finish-to-activate value producer 1116, a hypothetical finish-to-activate value applier 1118, a hypothetical minimum required duration calculator 1120, and a map constructor 1122.

The range database 1016 may store lower and upper endpoints of a range of hypothetical finish-to-activate duration values and the step size 1018 database may store the step size to be applied between the range endpoints.

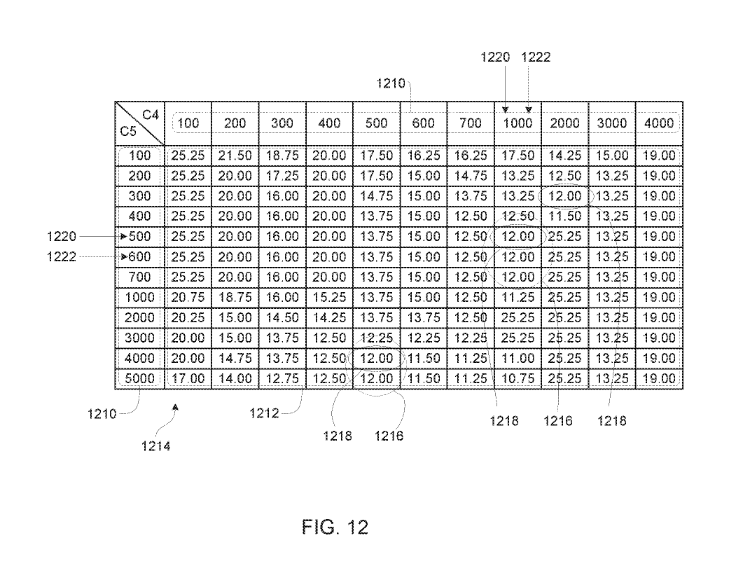

The hypothetical finish-to-activate value producer 1116 may retrieve the range of hypothetical finish-to-activate duration values from the range database 1016. The hypothetical finish-to-activate value producer 1116 may also retrieve the step size from the step size database 1018. Further, the hypothetical FTA value producer 1116 may apply the step size to the range to produce hypothetical finish-to-activate values 1210, examples of which are shown in FIG. 12.

The hypothetical finish-to-activate value applier 1118 may receive aperiodic task information from the pseudo-periodic modeler 312. The hypothetical finish-to-activate value applier 1118 may receive the hypothetical finish-to-activate values 1210 from the hypothetical FTA value producer 1116. Additionally, the hypothetical FTA value applier 1118 may apply the hypothetical finish-to-activate values 1210 to the aperiodic task of the partition under consideration. FIG. 12 illustrates an example of the hypothetical finish-to-activate values 1210 applied to example aperiodic tasks “C4” and “C5.”

The hypothetical minimum required duration calculator 1120 may then calculate hypothetical minimum required durations 1212—examples of which are shown in FIG. 12—using the aperiodic task and the respectively applied hypothetical finish-to-activate values 1210. In some examples, the hypothetical minimum required duration calculator 1120 may compute a respective hypothetical minimum required duration 1212 for the partition under consideration based on the aperiodic task and each hypothetical finish-to-activate value 1210. That is, the hypothetical minimum required duration calculator 1120 may generate a hypothetical minimum required duration 1212 for the partition under consideration for each combination of hypothetical finish-to-activate duration 1210 and aperiodic task.

The map constructor 1122 may collect the hypothetical minimum required durations 1212 and may construct an ordered frontier map 1214 of the hypothetical minimum required durations 1212. It should be understood that the frontier map 1214 may be a set of possible minimum required duration (e.g., budget) values. Further, the map constructor 1122 may send the frontier map to the schedulability verifier 318.

The schedulability verifier 318 may attempt to match the hypothetical minimum required durations 1212 with the extant budget held by the extant budget store 612 of FIG. 6.

The schedulability verifier 318 additionally may select the overall better combinations of hypothetical finish-to-activate values 1210 which yield the hypothetical minimum required durations 1212 that match the extant budget, as will be described in greater detail below in conjunction with FIG. 12. Thus, it should be understood that the schedulability verifier 318 may find the finish-to-activate solution by working backwards from the extant budget-matching hypothetical minimum required durations 1212 to the overall better combinations of hypothetical finish-to-activate values 1210. In cases where the schedulability verifier 318 cannot find a matching hypothetical minimum required duration 1212, the schedulability verifier 318 may request an increased budget from the final calculator 412 of FIGS. 4, 6, and 7 via the budget extension requestor 714 of FIG. 7. Examples of determining the overall better combinations of hypothetical finish-to-activate values 1210 will be described below with the aid of FIG. 12.

Focusing on FIG. 12 as an example, supposing the extant budget held by the extant budget store 612 were 12 ms, the schedulability verifier 318 may find the hypothetical minimum required durations 1212 that have a matching value of 12 ms. Continuing with the example of FIG. 12, the multiple hypothetical minimum required durations 1212 that match the extant budget under a like hypothetical finish-to-activate value 1210 may form a group 1216. In some examples, particular hypothetical minimum required durations 1212 that match the extant budget may represent a more optimal finish-to-activate solution than other hypothetical minimum required durations 1212 that match the extant budget. The overall better extant budget-matching hypothetical minimum required durations 1212 may be referred to as a frontier 1218. It should be understood that the frontier map 1214 may include multiple values belonging to the frontier 1218. Criteria for determining which of the extant budget-matching hypothetical minimum required durations 1212 belong to the frontier 1218 are described in greater detail below. It should also be understood that values belonging to the frontier 1218 may be boundary values associated with the minimum required duration (e.g., budget). Once the schedulability verifier 318 has located values belonging to the frontier 1218 in the frontier map 1214, the schedulability verifier 318 may select the overall better combinations of hypothetical finish-to-activate values 1210 which produced the values of the frontier 1218, as described in further detail below. It should be understood that multiple overall better combinations of hypothetical finish-to activate values 1210 may exist. Thus, the frontier 1218 may be a Pareto optimality frontier, where optimality corresponds to minimization of finish-to-activate values (e.g., faster aperiodic response times). Therefore, under a particular partition time budget, design tradeoffs for aperiodic tasks may be revealed by the frontier map 1214 along the frontier 1218.

In some examples, the schedulability verifier 318 may determine which hypothetical minimum required durations 1212 belong to the frontier 1218 by evaluating combinations of hypothetical finish-to-activate values 1210 according to algorithm 1, where (x₁, x₂, xᵢ, . . . , xₙ) is a combination of hypothetical finish-to-activate values 1210, X is an abbreviation for (x₁, x₂, xᵢ, . . . , xₙ), (y₁, y₂, yᵢ, . . . , yₙ) is another combination of hypothetical finish-to-activate values 1210, and Y is an abbreviation for (y₁, y₂, yᵢ, . . . , yₙ). It also should be understood that a combination of hypothetical finish-to-activate values 1210 may be referred to as feasible in examples where the combination yields an extant budget-matching hypothetical minimum required duration 1212.

X=(x₁, x₂, xᵢ, . . . , xₙ) belongs to the frontier 1218 and is therefore an overall better combination of hypothetical finish-to-activate values 1210 if:
X is feasible and
there is no other combination Y=(y₁, y₂, yᵢ, . . . , yₙ) where

Y≠X,
Y is feasible, and

yᵢ≦xᵢ. Algorithm 1

It should be understood that X and Y may be multidimensional combinations of the hypothetical finish-to-activate values 1210 respectively applied to the aperiodic tasks of the partition under consideration. That is, the n of xₙ and yₙ may be equal to the number of aperiodic tasks in the partition under consideration. As shown in the example of FIG. 12, because the partition under consideration has two aperiodic tasks “C4” and “C5,” the frontier map 1214 is two dimensional. In a particular example of FIG. 12, first and second combinations 1220, 1222 each have two constituent parts, and first and second combinations 1220, 1222 may respectively be expressed as (1000, 500) and (1000, 600). Applying algorithm 1 to the particular example first and second combinations 1220, 1222 of FIG. 12, supposing the first combination 1220 is X to make X=(x₁, x₂)=(1000, 500) and supposing the second combination 1222 is Y to make Y=(y₁, y₂)=(1000, 600), X belongs to the frontier 1218 and is thus an overall better combination of hypothetical finish-to-activate values 1210 because X yields an extant budget-matching hypothetical minimum required duration 1212 of 12 ms and, although Y is unequal to X and feasible, y₂>x₂ (600>500). Further applying algorithm 1 to the example of FIG. 12, Y does not belong to the frontier 1218 and is not an overall better combination of the hypothetical finish-to-activate values 1210 because X, which has an x₂<y₂, exists. It should be understood that the first combination 1220 is a particular example of a combination of hypothetical finish-to-activate values 1210 that belongs to the frontier 1218. In the illustrated example of FIG. 12, under Algorithm 1, combinations (500, 4000) and (2000, 300) additionally belong to the frontier 1218 in the same way that first combination 1220 belongs to the frontier 1218 above. Further, in the example of FIG. 12, under Algorithm 1, combination (500, 5000) does not belong to the frontier 1218 in the same way that second combination 1222 does not belong to the frontier 1218 above (e.g., because combination (500, 4000) exists).

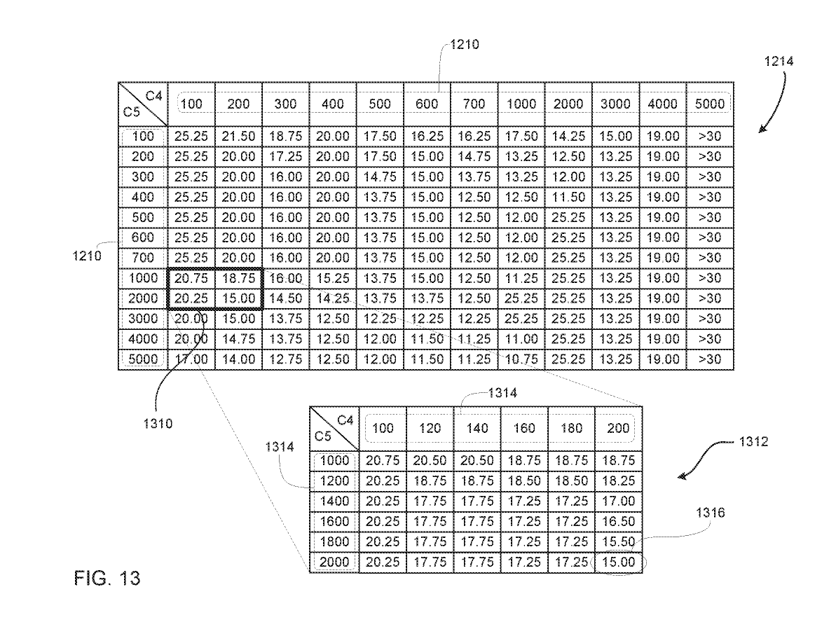

Thus, for example, under Algorithm 1, a particular combination of hypothetical finish-to-activate values 1210 yields a hypothetical minimum required duration 1212 that belongs to the frontier 1218 and is therefore an overall better combination if the particular combination is feasible and all the other combinations that are feasible and different than the particular combination have constituent parts that are greater than the constituent parts of the particular combination Further, the example of FIG. 12 describes algorithm 1 graphically, as the hypothetical minimum required durations 1212 belonging to the frontier 1218 (e.g., yielded by the overall better combinations of hypothetical finish-to-activate values 1210) are located at the top and left most in the frontier map 1214 relative to the other extant budget-matching hypothetical minimum required durations 1212. However, in some examples, greater precision with respect to the overall better combinations of hypothetical finish-to-activate values 1210 may be desirable, as described below with the aid of FIGS. 11 and 13.

Turning to FIG. 13, in some examples, a subsection 1310 of the frontier map 1214 may be re-analyzed to yield a refined frontier map 1312. That is, the refined frontier map 1312 may have a higher resolution than the frontier map 1214. For example, refined hypothetical finish-to-activate values 1314 of the refined frontier map 1312 may be closer together than the hypothetical finish-to-activate values 1210 of the frontier map 1214. To generate the refined frontier map 1312, the resolution refiner 1114 of FIG. 11 may send a request to the hypothetical finish-to-activate value producer 1116 for the hypothetical FTA value producer 1116 to update the range and the step size.

In some examples, the updated range and step size may be smaller than the previous range and step size. Further, the frontier map finish-to-activate determiner 1112 may generate the refined frontier map 1312 based on the updated range and step size as described above. Additionally, the schedulability verifier 318 may analyze the refined frontier map 1312 as described above to determine a refined frontier 1316 and a refined overall better combination of hypothetical finish-to-activate values 1314. Example methods to implement the structures of FIG. 11 are further described below in conjunction with FIGS. 14-15 and 18.

While an example manner of implementing the environment 210 of FIG. 2 is illustrated in FIGS. 3-13, one or more of the elements, processes and/or devices illustrated in FIG. 3-13 may be combined, divided, re-arranged, omitted, eliminated and/or implemented in any other way. Further, the example system configuration identifier 212, the example pseudo-periodic modeler 312, the example minimum required duration determiner 314, the example finish-to-activate duration determiner 316, the example schedulability verifier 318, the example initial calculator 410, the example final calculator 412, the example local-time task worst case execution time identifier 510, the example local-time task period determiner 512, the example partition period identifier 514, the example global-time task worst case execution time identifier 516, the example global-time task period determiner 518, the example receiver 610, the example extant budget store 612, the example extender 614, the example solver 712, the example budget extension requestor 714, the example partition policer 810, the example task policer 812, the example pseudo-periodic finish-to-activate determiner 912, the example priority sorter 914, the example deadline identifier 916, the example worst case response time identifier 918, the example transformation zero duration assigner 920, the example sequential minimization finish-to-activate determiner 1012, the example iterator 1014, the example range database 1016, the example step size database 1018, the example frontier map finish-to-activate determiner 1112, the example hypothetical finish-to-activate value producer 1116, the example hypothetical finish-to-activate value applier 1118, the example hypothetical minimum required duration calculator 1120, the example map constructor 1122, the example resolution refiner 1114 and/or, more generally, the example finish-to-activate method selector 214, the example analyzer 216, and the example scheduler 218 of FIGS. 2-13 may be implemented by hardware, software, firmware and/or any combination of hardware, software and/or firmware. Thus, for example, any of the example system configuration identifier 212, the example pseudo-periodic modeler 312, the example minimum required duration determiner 314, the example finish-to-activate duration determiner 316, the example schedulability verifier 318, the example initial calculator 410, the example final calculator 412, the example local-time task worst case execution time identifier 510, the example local-time task period determiner 512, the example partition period identifier 514, the example global-time task worst case execution time identifier 516, the example global-time task period determiner 518, the example receiver 610, the example extant budget store 612, the example extender 614, the example solver 712, the example budget extension requestor 714, the example partition policer 810, the example task policer 812, the example pseudo-periodic finish-to-activate determiner 912, the example priority sorter 914, the example deadline identifier 916, the example worst case response time identifier 918, the example transformation zero duration assigner 920, the example sequential minimization finish-to-activate determiner 1012, the example iterator 1014, the example range database 1016, the example step size database 1018, the example frontier map finish-to-activate determiner 1112, the example hypothetical finish-to-activate value producer 1116, the example hypothetical finish-to-activate value applier 1118, the example hypothetical minimum required duration calculator 1120, the example map constructor 1122, the example resolution refiner 1114 and/or, more generally, the example finish-to-activate method selector 214, the example analyzer 216, and the example scheduler 218 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, the example system configuration identifier 212, the example pseudo-periodic modeler 312, the example minimum required duration determiner 314, the example finish-to-activate duration determiner 316, the example schedulability verifier 318, the example initial calculator 410, the example final calculator 412, the example local-time task worst case execution time identifier 510, the example local-time task period determiner 512, the example partition period identifier 514, the example global-time task worst case execution time identifier 516, the example global-time task period determiner 518, the example receiver 610, the example extant budget store 612, the example extender 614, the example solver 712, the example budget extension requestor 714, the example partition policer 810, the example task policer 812, the example pseudo-periodic finish-to-activate determiner 912, the example priority sorter 914, the example deadline identifier 916, the example worst case response time identifier 918, the example transformation zero duration assigner 920, the example sequential minimization finish-to-activate determiner 1012, the example iterator 1014, the example range database 1016, the example step size database 1018, the example frontier map finish-to-activate determiner 1112, the example hypothetical finish-to-activate value producer 1116, the example hypothetical finish-to-activate value applier 1118, the example hypothetical minimum required duration calculator 1120, the example map constructor 1122, the example resolution refiner 1114 and/or, the example finish-to-activate method selector 214, the example analyzer 216, and the example scheduler 218 is/are hereby expressly defined to include a tangible computer readable storage device or storage disk such as a memory, a digital versatile disk (DVD), a compact disk (CD), a Blu-ray disk, etc. storing the software and/or firmware. Further still, the example analyzer 216 of FIG. 2 may include one or more elements, processes and/or devices in addition to, or instead of, those illustrated in FIG. 3, and/or may include more than one of any or all of the illustrated elements, processes and devices.

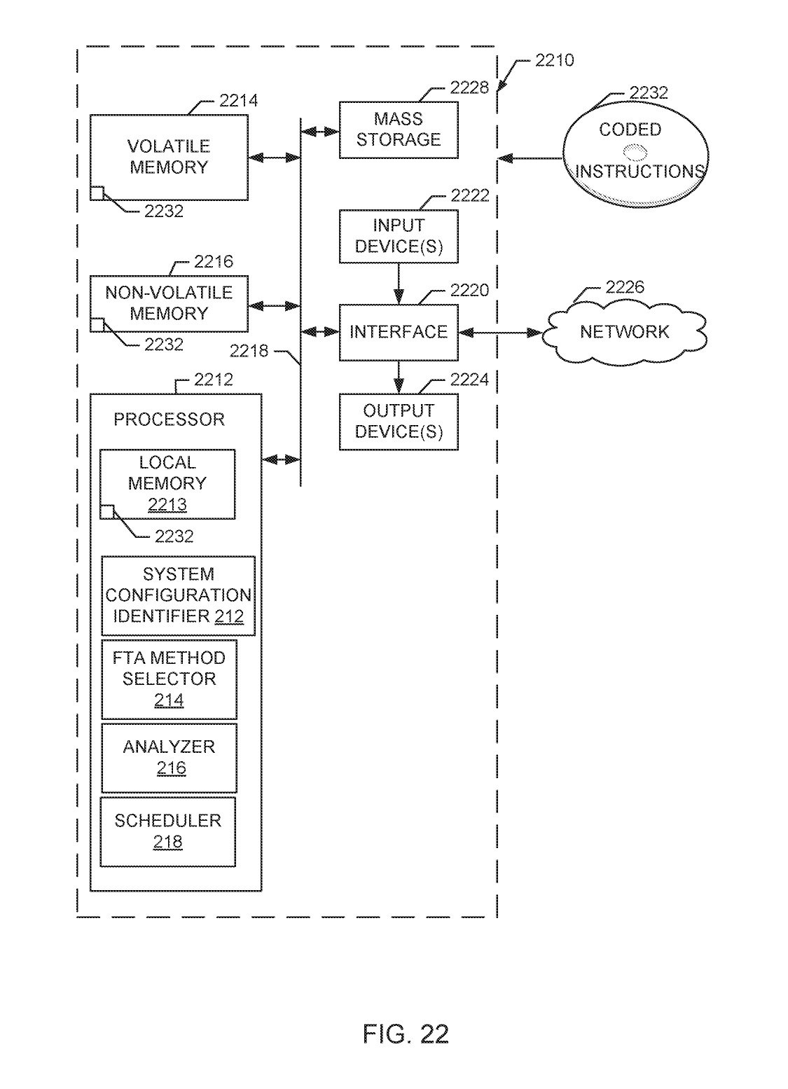

Flowcharts representative of example machine readable instructions for implementing the environment 210 of FIG. 2 are shown in FIGS. 14-21. In this example, the machine readable instructions comprise a program for execution by a processor such as the processor 2212 shown in the example processor platform 2210 discussed below in connection with FIG. 22. The program may be embodied in software stored on a tangible computer readable storage medium such as a CD-ROM, a floppy disk, a hard drive, a digital versatile disk (DVD), a Blu-ray disk, or a memory associated with the processor 2212, but the entire program and/or parts thereof could alternatively be executed by a device other than the processor 2212 and/or embodied in firmware or dedicated hardware. Further, although the example program is described with reference to the flowcharts illustrated in FIGS. 14-21, many other methods of implementing the example environment 210 may alternatively be used. For example, the order of execution of the blocks may be changed, and/or some of the blocks described may be changed, eliminated, or combined.

As mentioned above, the example processes of FIGS. 14-21 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 14-21 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

A program 1410 of FIG. 14 begins at block 1412 where the environment may determine whether the modification of a task schedule of a partition is feasible. Example methods for determining whether schedule modification is feasible are described below in conjunction with FIG. 15.

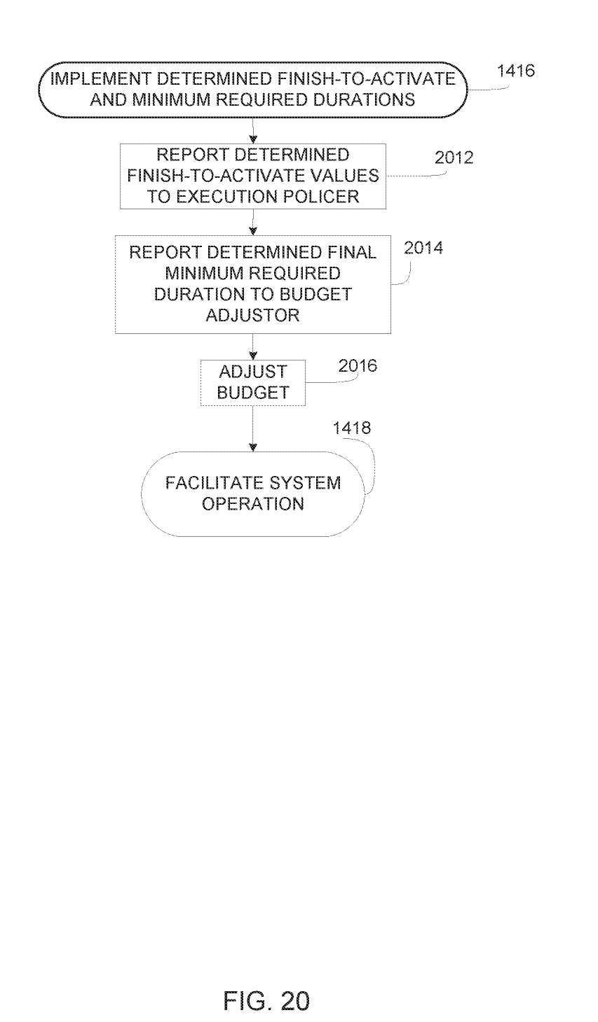

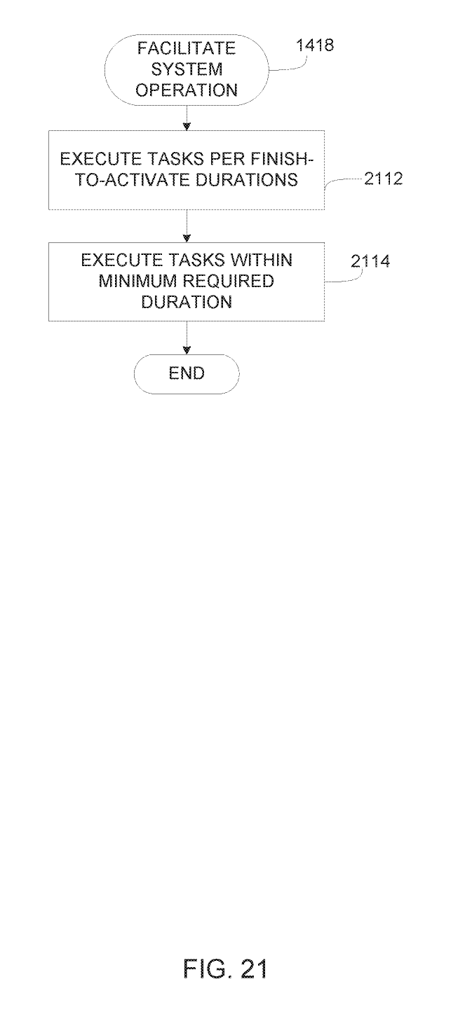

If modification of the task schedule is feasible, the environment may determine a minimum required duration of the partition and finish-to-activate durations of tasks (block 1414). Example methods for determining the minimum required duration and the finish-to-activate durations are to be further described below in conjunction with FIGS. 16-19. The environment may implement the determined minimum required durations and the finish-to-activate durations in the system (block 1416). Example methods for implementing the determined minimum required durations and the finish-to-activate durations are to be further described below in conjunction with FIG. 20. The system may operate according to the latest determined minimum required durations and finish-to-activate durations (block 1418) and the program 1410 may end. Example methods for operating the system with the latest determined minimum required durations and finish-to-activate durations are to be further described below in conjunction with FIG. 21.

If modification of the task schedule is not feasible, the system may be confidently operated as already optimized according to the extant determined minimum required duration (e.g., the budget) and the finish-to-activate duration (block 1418) and the program 1410 may end.

It should be understood that, in some examples, after the program 1410 ends, the program 1410 may return to block 1412 re-evaluate schedule modification after a waiting period. In further examples, the waiting period may be predetermined.

Referring to FIG. 15, the program 1410 of FIG. 14 may more specifically begin at block 1412 to determine whether schedule modification is feasible. The system configuration identifier may select an application (block 1512). The system configuration identifier may select a partition of the selected application (block 1514). The system configuration identifier may identify global-time and local-time tasks of the selected partition and may identify periodic and aperiodic tasks of the selected partition (block 1516). The pseudo-periodic modeler may generate pseudo-periodic models of the identified aperiodic tasks (block 1518). The local-time task period determiner may retrieve the periods of local-time tasks and may determine the periods of local-time pseudo-periodic models (block 1520). The global-time task period determiner further may retrieve the periods of the global-time tasks and may determine the periods of the global-time pseudo-periodic models (block 1522). The local-time task worst case execution time identifier may retrieve the worst case execution times of the local-time tasks and the global-time task worst case execution time identifier may retrieve the worst case execution times of the global-time tasks (block 1524). The partition period identifier may retrieve the period of the selected partition (block 1526). The initial calculator may determine the initial minimum required duration of the selected partition according to Equation 1 based on the worst case execution times and the periods of the tasks, the models, and the selected partition (block 1528). The schedulability verifier may determine whether the extant time budget of the selected partition is at least the initial minimum required duration (block 1530).

If the existing time budget of the selected partition is less than the initial minimum required duration, the extender may add time to the extant time budget of the selected partition and return to the determination of block 1530 (block 1532).

If the extant time budget of the selected partition is at least the initial minimum required duration, the schedulability verifier may determine whether the selected partition has aperiodic tasks (block 1540).

If the selected partition does not have aperiodic tasks, schedule modification may be skipped and the final calculator may rename the initial minimum required duration as the final minimum required duration (block 1542) and the system may operate according to the latest determined minimum required durations (block 1418).

If the selected partition includes aperiodic tasks, schedule modification may be applicable and the program may determine the finish-to-activate and the minimum required durations (block 1414).

As shown in FIG. 16, program 1410 of FIG. 14 may more specifically begin at block 1414 to determine the finish-to-activate and minimum required durations. The finish-to-activate method selector may select a search method (block 1612). In some examples, the finish-to-activate method selector may select a pseudo-periodic method (block 1614). In other examples, the finish-to-activate method selector may select a sequential minimization method (block 1616). In further examples, the finish-to-activate method selector may select a frontier map method (block 1618).

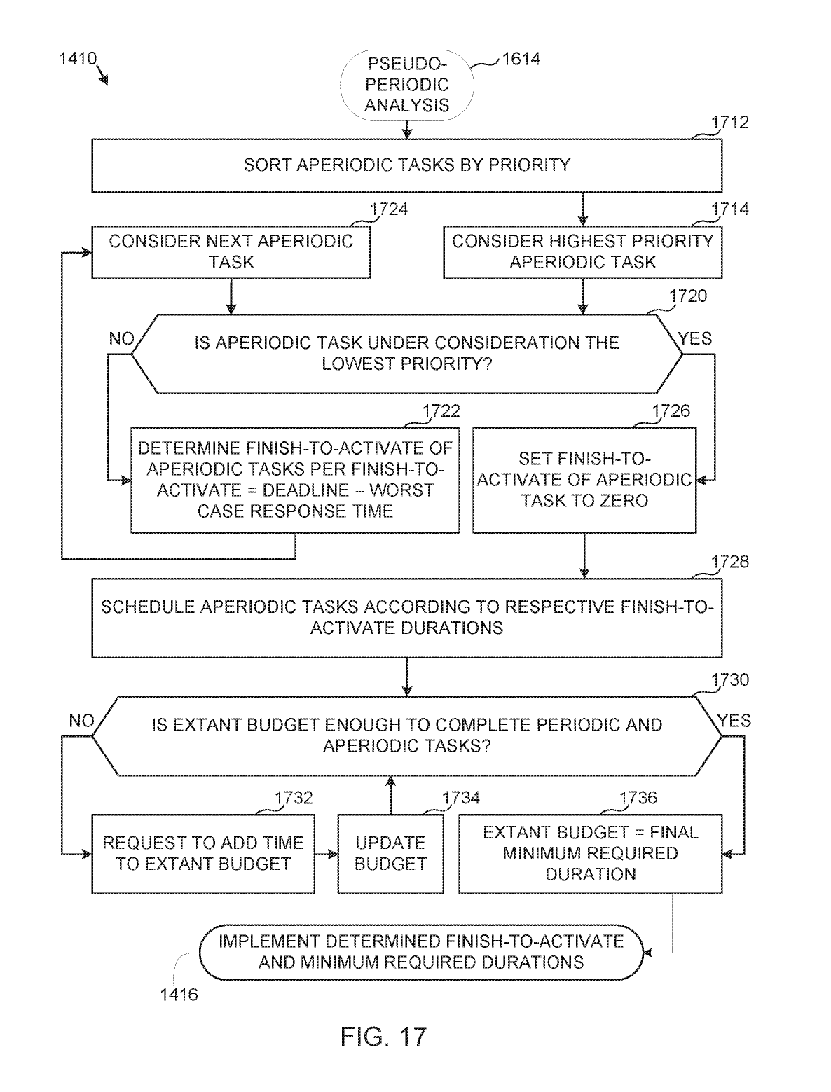

As shown in FIG. 17, if the finish-to-activate method selector selects the pseudo-periodic method (block 1614), the priority sorter may sort the aperiodic tasks by respective priorities of the aperiodic tasks (block 1712). The priority sorter may consider the highest priority aperiodic task (block 1714). The priority sorter may determine whether the aperiodic task under consideration is the lowest priority (block 1720).

If the aperiodic task under consideration is not the lowest priority, the transformation calculator may determine the finish-to-activate duration of the aperiodic task under consideration based on Equation 2, above (block 1722). The priority sorter may consider the next priority aperiodic task (block 1724).

If the aperiodic task under consideration is the lowest priority, the transformation zero duration assigner may assign the aperiodic task with a finish to activate duration of zero (block 1726). The schedulability verifier may schedule the periodic and aperiodic tasks according to the respective finish-to-activate durations of the aperiodic tasks (block 1728). The schedulability verifier may determine whether the scheduled aperiodic and periodic tasks can be completed in the extant budget (block 1730).

If the scheduled aperiodic and periodic tasks cannot be completed in the extant budget, the schedulability verifier may request the final calculator to add time to the extant budget via the budget extension requestor (block 1732). The extender may receive the request via the receiver, may add time to the extant budget stored in the extant budget store, and may return the updated increased budget to the schedulability verifier via the receiver (block 1734).

If the periodic and aperiodic tasks can be completed in the extant budget, the schedulability verifier may rename the extant budget as the final minimum required duration (block 1736) and the program 1410 may implement the determined final minimum required duration and the finish-to-activate durations (block 1416).

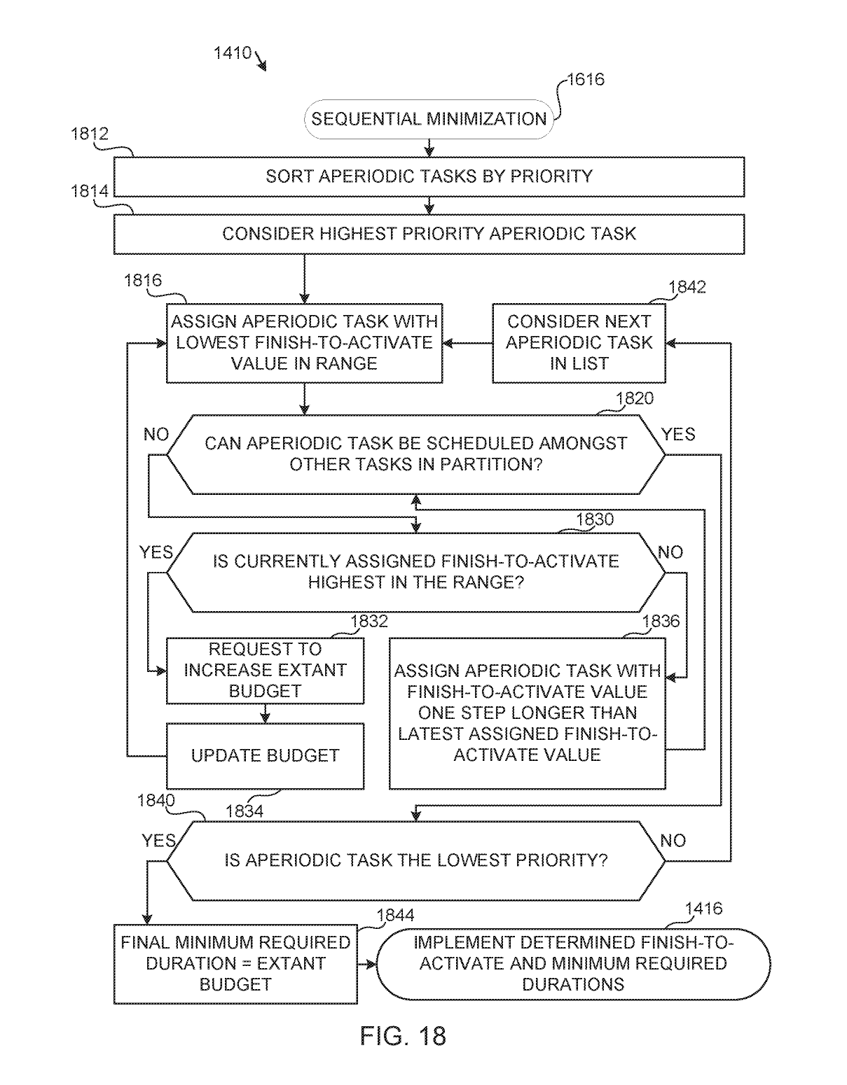

As shown in FIG. 18, if the finish-to-activate method selector selects the sequential minimization method (block 1616), the priority sorter may sort the aperiodic tasks by respective priorities of the aperiodic tasks (block 1812). The priority sorter may consider the highest priority aperiodic task (block 1814). The iterator may assign the aperiodic task under consideration with the lowest sample finish-to-activate value in the range (block 1816). The schedulability verifier may determine whether the aperiodic task under consideration can be scheduled amongst the periodic and aperiodic tasks of the selected partition according to the assigned finish-to-activate duration with respect to the extant budget (block 1820).

If the aperiodic task under consideration cannot be scheduled, the schedulability verifier may determine whether the latest assigned sample finish-to-activate value is the highest in the range (block 1830).

If the aperiodic task under consideration can be scheduled, the schedulability verifier may determine whether the aperiodic task under consideration is the lowest priority (block 1840).

If the latest assigned sample finish-to-activate value is the highest in the range, the schedulability verifier may request the final calculator to increase the extant budget via the budget extension requestor (block 1832). The extender may receive the request via the receiver, may add time to the extant budget stored in the extant budget store, and may return the updated increased budget duration to the schedulability verifier via the receiver (block 1834).

If the latest assigned sample finish-to-activate value is not the highest in the range, the schedulability verifier may request a sample finish-to-activate value from the iterator one step larger than the latest assigned sample finish-to-activate value for the aperiodic task under consideration (block 1836).

If the aperiodic task under consideration is not the lowest priority, the priority sorter may consider the next priority aperiodic task (block 1842).

If the aperiodic task under consideration is the lowest priority, the schedulability verifier may rename the extant budget as the final minimum required duration (block 1844) and the program 1410 may implement the determined final minimum required durations and the finish-to-activate durations (block 1416).

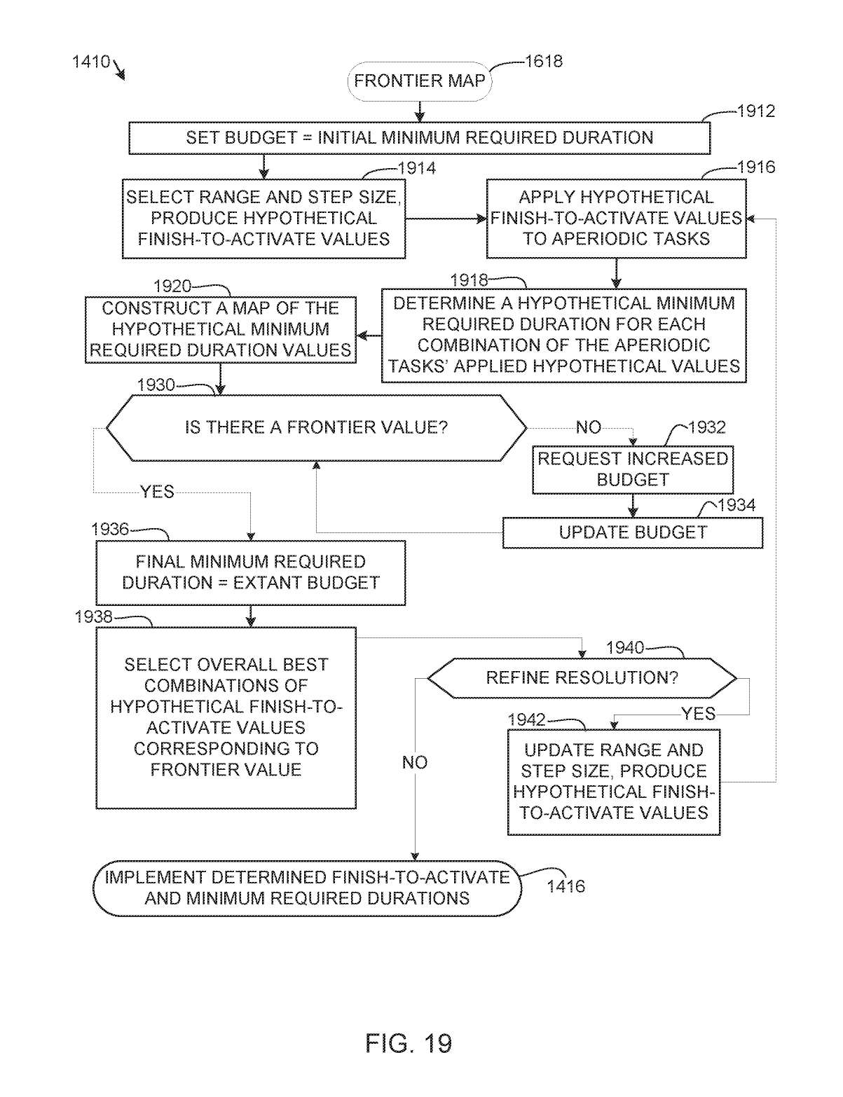

As shown in FIG. 19, if the finish-to-activate method selector selects the frontier map method (block 1618), the schedulability verifier may set the extant budget to be the initial minimum required duration (block 1912). The hypothetical finish-to-activate value producer may select a range and a step size and produce hypothetical finish-to-activate values for each aperiodic task in the selected partition (block 1914). The hypothetical finish-to-activate value applier may apply the hypothetical finish-to-activate values to each aperiodic task under consideration (block 1916). The hypothetical minimum required duration calculator may determine a hypothetical minimum required duration for each combination of the hypothetical finish-to-activate values as applied to the aperiodic tasks (block 1918). The map constructor may construct an ordered frontier map of the hypothetical minimum required values (block 1920). The schedulability verifier may determine whether a frontier exists amongst the hypothetical minimum required durations that match the initial minimum required duration according to Algorithm 1 (block 1930).

If a frontier does not exist, the schedulability verifier may request the final calculator to increase the extant budget via the window extension requestor (block 1932). The extender may receive the request via the receiver, may add time to the extant budget stored in the extant budget store, and may return the updated increased budget to the schedulability verifier via the receiver and the program 1410 may return to block 1930 (block 1934).

If a frontier does exist, the schedulability verifier may rename the extant budget as the final minimum required duration (block 1936). The schedulability verifier may select the overall better combinations of hypothetical finish-to-activate values corresponding to the hypothetical minimum required durations belonging to the frontier (block 1938). The resolution refiner may determine whether to refine the resolution of the frontier map (block 1940).

If the resolution of the frontier map should be refined, the hypothetical finish-to-activate value producer may update the range and step size of the hypothetical values and the program 1410 may return to block 1716 (block 1942).

If the resolution of the frontier map is adequate, the program 1410 may implement the determined final minimum required durations and the finish-to-activate durations (block 1416).

As shown in FIG. 20, program 1410 of FIG. 14 may more specifically begin at block 1416 to implement the finish-to-activate and minimum required durations. The finish-to-activate determiner may report the determined finish-to-activate durations to the task policer (block 2012). The minimum required duration determiner may report the determined final minimum required duration to the partition policer (block 2014). The partition policer may adjust the budget according to the final minimum required duration (block 2016). The system may operate according to the latest implemented finish-to-activate and minimum required durations (block 1418).

As shown in FIG. 21, program 1410 of FIG. 14 may more specifically begin at block 1418 to operate the system according to the latest implemented finish-to-activate and minimum required durations. The task policer may execute tasks according to the finish-to-activate durations (block 2112) (e.g., as shown in the example of FIG. 1 where first aperiodic task 118 reactivates after finish-to-activate durations 128). The system may schedule the partition according to the minimum required duration (block 2114) (e.g., as shown in the example of FIG. 1 where budget 112 is long enough to execute jobs 130, 132, 134, 136, 138) and the program may end. As above, in some examples, the program 1410 may return to block 1412 of FIG. 14 to reevaluate schedule modification (e.g., due to new applications being loaded in the system, application updates, operating system updates, loss of memory, loss of power, a power surge, changes to digital configurations, etc.).

FIG. 22 is a block diagram of an example processor platform 2210 capable of executing the instructions of FIGS. 14-21 to implement the environment 210 of FIG. 2. The processor platform 2210 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 2210 of the illustrated example includes a processor 2212. The processor 2212 of the illustrated example is hardware. For example, the processor 2212 can be implemented by one or more integrated circuits, logic circuits, microprocessors or controllers from any desired family or manufacturer. In the illustrated example, the processor 2212 is structured to include the example system configuration identifier 212, the example finish-to-activate method selector 214, the example analyzer 216, and the example scheduler 218.

The processor 2212 of the illustrated example includes a local memory 2213 (e.g., a cache). The processor 2212 of the illustrated example is in communication with a main memory including a volatile memory 2214 and a non-volatile memory 2216 via a bus 2218. The volatile memory 2214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 2216 may be implemented by flash memory and/or any other desired type of memory device. Access to the main memory 2214, 2216 is controlled by a memory controller.

The processor platform 2210 of the illustrated example also includes an interface circuit 2220. The interface circuit 2220 may be implemented by any type of interface standard, such as an Ethernet interface, a universal serial bus (USB), and/or a PCI express interface.

In the illustrated example, one or more input devices 2222 are connected to the interface circuit 2220. The input device(s) 2222 permit(s) a user to enter data and commands into the processor 2212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 2224 are also connected to the interface circuit 2220 of the illustrated example. The output devices 2224 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 2220 of the illustrated example, thus, typically includes a graphics driver card, a graphics driver chip or a graphics driver processor.

The interface circuit 2220 of the illustrated example also includes a communication device such as a transmitter, a receiver, a transceiver, a modem and/or network interface card to facilitate exchange of data with external machines (e.g., computing devices of any kind) via a network 2226 (e.g., an Ethernet connection, a digital subscriber line (DSL), a telephone line, coaxial cable, a cellular telephone system, etc.).

The processor platform 2200 of the illustrated example also includes one or more mass storage devices 2228 for storing software and/or data. Examples of such mass storage devices 2228 include floppy disk drives, hard drive disks, compact disk drives, Blu-ray disk drives, RAID systems, and digital versatile disk (DVD) drives.

The coded instructions 2232 of FIG. 22 may be stored in the mass storage device 2228, in the volatile memory 2214, in the non-volatile memory 2216, and/or on a removable tangible computer readable storage medium such as a CD or DVD.

From the foregoing, it will be appreciated that the above disclosed methods, apparatus and articles of manufacture may improve the functioning of a computer system by aiding a processor of the computer system to operate more quickly and efficiently. Certain examples alter normal operation of the processor to process periodic and aperiodic tasks differently than a traditional computer processor. Further, improved performance of the processor through efficient partition task scheduling may conserve energy. Moreover, adjusting processor operation to execute tasks according to finish-to-activate scheduling may provide faster, more efficient output. Improved task scheduling may provide more efficient, yet safe, usage of available system time budget based on finish-to-activate time between consecutive jobs of a given task, as well as a minimum required duration of the system with respect to timing requirements. Certain examples develop objective functions and methods to efficiently utilize system time budget, including pseudo-periodic analysis based methods, sequential optimization based methods, and efficient frontier based methods.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to schedule tasks, comprising:
identifying a periodic task;
identifying an aperiodic task;
determining an initial minimum required duration based on the periodic and aperiodic tasks;
determining a finish-to-activate duration of the aperiodic task;
determining a final minimum required duration based on the initial minimum required duration and the finish-to-activate duration;
adjusting a time budget to be the final minimum required duration; and
scheduling the aperiodic task within the time budget and with respect to the periodic task and the finish-to-activate duration.

2. A method as defined in claim 1, further comprising
determining a period of the periodic task;
determining a period of a partition;
generating a pseudo-periodic task model of the aperiodic task; and
determining a period of the pseudo-periodic task model.

3. A method as defined in claim 2, wherein the determining of an initial minimum required duration based on the periodic and aperiodic tasks is further based on a predetermined worst-case execution time of the periodic task, the period of the periodic task, the period of the partition, the worst-case execution duration of the pseudo-periodic task model, and the period of the pseudo-periodic task model.

4. A method as defined in claim 1, wherein the adjusting the time budget to be the final minimum required duration increases the time budget.

5. A method as defined in claim 2, further comprising
determining a worst-case response time of the pseudo-periodic task model.

6. A method as defined in claim 5, wherein the determining of the finish-to-activate duration of the aperiodic task is based on a predetermined deadline of the aperiodic task and the worst-case response duration of the pseudo-periodic task model.

7. A method as defined in claim 1, wherein the determining of the finish-to-activate duration of the aperiodic task includes sequentially searching for a minimal finish-to-activate duration.

8. A method as defined in claim 1, wherein the determining of the finish-to-activate duration of the aperiodic task includes
constructing a frontier map of hypothetical minimum required durations based on a database of predetermined finish-to-activate sample values;
locating a frontier in the frontier map; and
selecting the finish-to-activate duration based on the frontier.

9. An apparatus to schedule tasks, comprising:
a processor and a memory including instructions which, when executed, cause the processor to:
identify a periodic task;
identify an aperiodic task;
determine an initial minimum required duration based on the periodic and aperiodic tasks;
determine a finish-to-activate duration of the aperiodic task;
determine a final minimum required duration based on the initial minimum required duration and the finish-to-activate duration;
adjust a time budget to be the final minimum required duration; and
scheduling the aperiodic task within the time budget and with respect to the periodic task and the finish-to-activate duration.

10. An apparatus as defined as in claim 9, wherein the instructions, when executing to cause the processor to determine the finish-to-activate duration of the aperiodic task, further cause the processor to
generate a pseudo-periodic model of the aperiodic task and
determine a worst-case response time of the pseudo-periodic model, wherein the finish-to-activate duration of the aperiodic task is based on a predetermined deadline of the aperiodic task and the worst-case response duration of the pseudo-periodic model.

11. An apparatus as defined in claim 9, wherein the instructions, when executing to cause the processor to determine the finish-to-activate duration of the aperiodic task, further cause the processor to:
sequentially search for a minimal finish-to-activate duration.

12. An apparatus as defined in claim 9, wherein the instructions, when executing to cause the processor to determine the finish-to-activate duration of the aperiodic task, further cause the processor to:
construct a frontier map of hypothetical minimum required durations based on a database of predetermined finish-to-activate sample values;
locate a frontier in the frontier map; and
select the finish-to-activate duration based on the frontier.

13. A tangible computer readable storage medium comprising computer readable instructions which, when executed, cause a processor to at least:
identify a periodic task;
identify an aperiodic task;
determine an initial minimum required duration based on the periodic and aperiodic tasks;
determine a finish-to-activate duration of the aperiodic task;
determine a final minimum required duration;
adjust a time budget to be the final minimum required duration; and
schedule the aperiodic task within the time budget and with respect to the periodic task and the finish-to-activate duration.

14. A tangible computer readable storage medium as defined in claim 13, wherein the computer readable instructions, when executed, further cause the processor to at least
determine a period of the periodic task;
determine a period of a partition;
generate a pseudo-periodic model of the aperiodic task; and
determine a period of the pseudo-periodic task model.

15. A tangible computer readable storage medium as defined in claim 14, wherein the instructions to determine the initial minimum required duration based on the periodic and aperiodic tasks are further based on a predetermined worst-case execution time of the periodic task, the period of the periodic task, the period of the partition, a predetermined worst-case execution duration of the pseudo-periodic model, and the period of the pseudo-periodic model.

16. A tangible computer readable storage medium as defined in claim 13, wherein the instructions to adjust the time budget to be the final minimum required duration increase the time budget.

17. A tangible computer readable storage medium as defined in claim 14, wherein the instructions further cause the processor to at least determine a worst-case response time of the pseudo-periodic model.

18. A tangible computer readable storage medium as defined in claim 17, wherein the instructions to determine the finish-to-activate duration of the aperiodic task are based on a predetermined deadline of the aperiodic task and the worst-case response duration of the pseudo-periodic model.

19. A tangible computer readable storage medium as defined in claim 13, wherein the instructions to determine the finish-to-activate duration of the aperiodic task further cause the processor to at least sequentially search for a minimal finish-to-activate duration.

20. A tangible computer readable storage medium as defined in claim 13, wherein the instructions to determine the finish-to-activate duration of the aperiodic task further cause the processor to at least
construct a frontier map based on a database of predetermined finish-to-activate sample values;
locate a frontier in the frontier map; and
select a finish-to-activate duration solution based on the frontier.
